(19) United States
(12) Patent Application Publication
(10) Pub. No.: US 2007/0022541 A1
(43) Pub. Date: Feb. 1, 2007

(54) Method for producing leather

(75) Inventors: Tilman Ludecke Taeger, Seeheim-Jugenheim (DE); Gunther Pabst, Mannheim (DE); Philippe Lamalle, Lambsheim (DE); Stephan Huffer, Ludwigshafen (DE); Stefan Schroeder, Neuleiningen (DE)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: BASF Aktiengessellschaft, Ludwigshafen (DE)

(21) Appl. No.: 10/529,744

(22) PCT Filed: Oct. 14, 2003
(86) PCT No.: PCT/EP03/11368

§ 371 Date: Mar. 29, 2005

(30) Foreign Application Priority Data
Oct. 21, 2002 (DE) 102 49 077.5

(51) Int. Cl. C14C 1/06

(52) U.S. Cl. 8/94.16

(57) ABSTRACT

Leather is produced by a process comprising at least two of the following process steps A) to D): A) use of one or more polyelectrolytes in the production of semifinished products or intermediate products, comprising the addition of one or more polyelectrolytes in at least one of the steps (a) to (d) (a) together with from 0 to 1.5% by weight, based on the salted weight, of lime, immediately before or during liming, (b) before or during deliming, (c) before or during bating, (d) together with, altogether, from 0 to 3% by weight, based on the pelt weight, of alkali metal or alkaline earth metal salt, immediately before or during pickling;
B) treatment of the hides during liming in an aqueous liquor with one or more compounds of the formula B.1 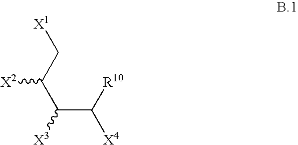
or the corresponding alkali metal, alkaline earth metal, ammonium or phosphonium salts thereof, R¹⁰ and X¹ to X⁴ having the meanings stated in the description, with the proviso that at least two mercapto groups are present in the compound or the compounds B.1;
   C) use of degreasing agents of the formula C.1 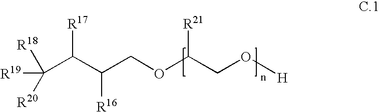
for degreasing pelts, hides or other intermediate stages and semifinished products in leather production, n and R¹⁶ to R²¹ having the meanings stated in the description;
   D) tanning with the use of a tanning agent which can be prepared by reacting at least one aldehyde of the formula D.1, 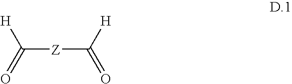
   with at least one further identical or different aldehyde of the formula D.1 in the presence of an acidic catalyst and optionally in the presence of at least one further carbonyl compound of the formula D.2 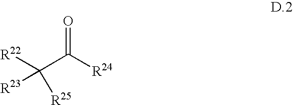
Z and R²² to R²⁵ having the meanings stated in the description, with the proviso that, when Z corresponds to a single chemical bond or a radical without α-hydrogen atoms, at least one further aldehyde of the formula D.1, in which Z contains α-hydrogen atoms, or at least one further carbonyl compound of the formula D.2 is present.

The present invention relates to a process for the production of leather, comprising at least two of the following process steps A) to D):
A) use of one or more polyelectrolytes for the production of semifinished products or intermediate products, comprising at least one of the steps (a) to (d)
   (a) addition of one or more polyelectrolytes and from 0 to 1.5% by weight, based on the salted weight, of lime, immediately before or during liming,
   (b) addition of one or more polyelectrolytes before or during deliming,
   (c) addition of one or more polyelectrolytes before or during bating,
   (d) addition of one or more polyelectrolytes and, altogether, from 0 to 3% by weight, based on the pelt weight, of alkali metal or alkaline earth metal salt, immediately before or during pickling;
B) treatment of the hides during liming in aqueous liquor with one or more compounds of the formula B.1 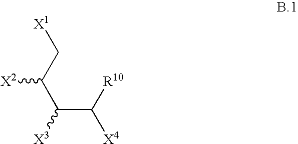
or the corresponding alkali metal, alkaline earth metal, ammonium or phosphonium salts thereof,
where:
   R¹⁰ is hydrogen or C₁-C₁₂-alkyl which is unsubstituted or substituted by one or more mercapto or hydroxyl groups,
   X¹ to X⁴, independently of one another, are hydrogen, C₁-C₄-alkyl, hydroxyl, mercapto or NHR¹¹ and
   R¹¹ is hydrogen, C₁-C₁₂-alkyl, formyl or C₁-C₄-alkylcarbonyl,
   with the proviso that at least two mercapto groups are contained in the compound or the compounds B.1;
C) use of degreasing agents of the formula C.1 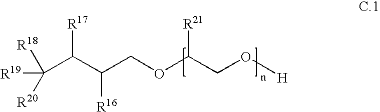
for degreasing pelts, hides or other intermediate products and semifinished products in leather production,
where:
   R¹⁶ to R¹⁹, independently of one another, are hydrogen or branched or straight-chain C₁-C₁₀-alkyl,
   R²⁰ is hydrogen or C₁-C₂₅-alkyl,
   R²¹ is hydrogen or C₁-C₄-alkyl and
   n is an integer from 1 to 100,
   R¹⁶ corresponding to C₁-C₁₀-alkyl when R¹⁸ to R²⁰ are each hydrogen
   and at least one of the radicals R¹⁸ to R²⁰ corresponding to C₁-C₂₅-alkyl when R¹⁶ is hydrogen;
D) tanning with the use of a tanning agent which can be prepared by reacting at least one aldehyde of the formula D.1, 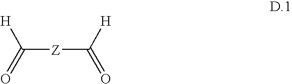
with at least one further identical or different aldehyde of the formula D.1,
where:
   Z is a single chemical bond, unsubstituted or substituted C₁-C₁₂-alkylene, unsubstituted or substituted C₅-C₁₂-cycloalkylene or unsubstituted or substituted C₆-C₁₄-arylene,
   the reaction being carried out in the presence of an acidic catalyst and optionally in the presence of at least one further carbonyl compound of the formula D.2 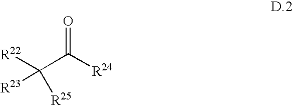
   where:
   R²² to R²⁵, independently of one another, are hydrogen, unsubstituted or substituted C₁-C₁₂-alkyl, unsubstituted or substituted C₃-C₁₂-cycloalkyl, unsubstituted or substituted C₇-C₁₃-aralkyl or unsubstituted or substituted C₆-C₁₄-aryl,
   with the proviso that at least one further aldehyde of the formula D.1 in which Z contains α-hydrogen atoms, or at least one further carbonyl compound of the formula D.2, is present when Z corresponds to a single chemical bond or to a radical without α-hydrogen atoms.

The present invention furthermore relates to leather which has been produced by the novel process.

In addition to the mechanical operation of fleshing and splitting of the rawhides, leather production in the beamhouse substantially comprises the physicochemical process steps of soaking, liming and unhairing, deliming, bating, pickling and tanning.

The conventional procedure usually results in large amounts of organic and inorganic wastes and correspondingly highly polluted wastewaters, which lead to increasingly critical problems in the tannery with regard to their disposal.

A critical step in leather production from ecological points of view is unhairing. It is effected, as a rule, more or less completely during liming, conventionally used and economical unhairing reagents being sodium sulfide and sodium hydrogen sulfide (often also referred to as sodium sulfhydrate). The two salts are usually used in industrial quality and thus in highly contaminated form, industrial sodium sulfide generally containing not more than 65% by weight of pure Na₂S and industrial sodium hydrogen sulfide not more than about 72% by weight of NaHS.

For safety reasons, both sodium sulfide and sodium hydrogen sulfide can be used only in a strongly alkaline medium because they release toxic and foul-smelling hydrogen sulfide on acidification. For digesting the rawhides and, associated therewith, also for establishing strongly alkaline conditions, quick lime or milk of lime (slurry of calcium oxide or calcium hydroxide in water) is additionally introduced during liming, which contributes to further inorganic wastewater pollution, in particular in the subsequent deliming step.

The elimination of the unconsumed sulfides, in particular of the sulfide-containing wastewaters, is also a critical step. If excess sulfide is precipitated, for example with Fe(II) and/or Fe(III) salts, iron sulfide sludges which are complicated to separate off and moreover further salt loads are obtained. On the other hand, corrosion problems are to be expected on oxidation of the sulfides to give ecologically acceptable salts, for example by means of hydrogen peroxide.

In the case of the conventional chrome tanning (production of “wet-blue” leathers), chromium-containing wastewaters are furthermore obtained. Here, the amounts of chromium salts used are typically from 1.5 to 8% by weight or more, based on the pelt weight of the leather. However, considerable portions of the salts are as a rule not bound and are present in the wastewater. Although the wastewater can be freed from considerable proportions of chromium, for example by chemical treatment with lime and iron salts, this results on the other hand in chromium-containing sludges which have to be disposed of on special landfills or worked up by a complicated procedure.

Furthermore, the chromium-containing wastes obtained during splitting and leveling of the hides/leathers—said wastes can account for up to 15% by weight, based on the hide weight—also have to be disposed of by a complicated procedure.

A comprehensive overview of the (currently) best available technique (BAT) for the tanning of leather is provided in this context by the study “Integrated Pollution Prevention and Control (IPPC)—Reference Document on Best Available Techniques for the Tanning of Hides and Skins” published by the European IPPC Office of the European Commission in May 2001 (available on the Internet under http://eippcb.jrc.es).

It is an object of the present invention to bring about improvements in waste management in the beamhouse by a procedure adapted with respect to the disposal requirements in the tanning of leather and hence generally to provide a process for leather production which protects resources and moreover gives tanned leathers which meet the high quality requirements.

We have found that this object is achieved by the process defined at the outset, which, according to the invention, comprises at least two of the process steps A) to D) defined in more detail below.

Process step A) comprises adding one or more polyelectrolytes in the production of semifinished products and intermediate products in leather production:
(a) together with from 0 to 1.5% by weight, based on the salted weight, of lime, immediately before or during liming,
(b) before or during deliming,
(c) before or during bating,
(d) together with, altogether, from 0 to 3% by weight, based on the pelt weight, of alkali metal or alkaline earth metal salt, immediately before or during pickling.

Semifinished products and intermediate products in leather production or in the production of skins are understood as meaning those semifinished products and intermediate products which the hides become after the various stages in the production of leather before the actual tanning, known to a person skilled in the art, for example, as pelts and pickled pelts.

Furthermore, the term “lime” mentioned under step (a) of process step A) is used in the context of the terminology customary in leather production and refers to slaked lime, CaO.H₂O (“Ca(OH)₂”).

In process step A), both organic and inorganic polyelectrolytes can be used, where organic polyelectrolytes are also to be understood as meaning bioorganic polyelectrolytes, e.g. protein hydrolysis products.

Organic polyelectrolytes are generally understood as meaning organic polymers which have a large number of groups capable of undergoing ionic dissociations and which may be an integral part of the polymer chains or may be attached to these as side groups. In general, each of the random repeat units carries at least one group capable of undergoing ionic dissociation in aqueous solution. In the context of the present invention, ionomers are also included among the organic polyelectrolytes, these being organic polymers in which many repeating units carry a group capable of undergoing ionic dissociation, but not every repeating unit does so. Polymers having only one or two ionizable groups at the respective chain ends or, in the case of branched polymers, having a number of groups capable of undergoing dissociation, corresponding to the number of chain ends, are not included among polyelectrolytes in the context of the present invention.

In the novel process, poly bases, poly acids, polyampholytes or the poly salts thereof or mixtures thereof can be used. Poly acids are to be understood as meaning those organic polyelectrolytes which dissociate in an aqueous medium with elimination of protons, for example with vinylsulfonic acid, vinylsulfuric acid, vinylphosphonic acid, methacrylic acid or acrylic acid as repeating units. Poly bases are to be understood as meaning those organic polyelectrolytes which contain groups or radicals which can be protonated by reaction with Brønsted acids, for example polyethylenimines, polyvinylamines or polyvinylpyridines. Polyampholytes are usually understood as meaning those polymers which contain both repeating units which dissociate in an aqueous medium with elimination of protons and repeating units which can be protonated by reaction with Bronsted acids. Poly salts are usually understood as meaning singly or in particular multiply deprotonated poly acids.

Preferably, synthetic polyelectrolytes are used in process step A) of the novel process.

The organic polyelectrolytes used in process step A) of the novel process are known as such and preferably contain at least three identical or different repeating units of the formulae A.1 to A.4

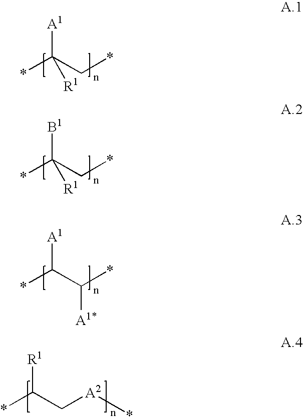

Polyelectrolytes in the context of the present invention are also to be understood as meaning those polymers which have repeating units A.1 to A.4 and are present not in linear form but in branched, crosslinked, hyperbranched or dendrimeric form and in which repeating units A¹, A² and/or A¹* are not exclusively terminal units.

Other organic polyelectrolytes which may be used in the novel process have at least 3 repeating units of the formulae A.5.a or A.5.b: 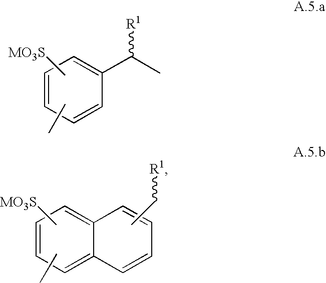
it also being possible for disulfonated or polysulfonated repeating units to be present as a result of the preparation.

In A.1 to A.5.b, the variables are defined as follows:
n is an integer from 3 to 50 000, preferably from 20 to 10 000, particularly preferably up to 5 000,
A¹ and A¹* are ionic or ionizable groups of the formulae A.6 to A.13 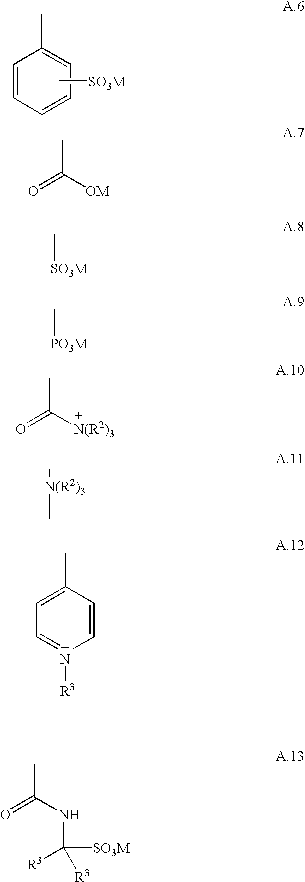
in which the variables are defined as follows:
R¹, in each case independently of one another, are hydrogen, OH, CN,
   C₁-C₂₀-alkyl, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl, n-decyl, n-dodecyl, n-hexadecyl or n-eicosyl; preferably C₁-C₆-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl or sec-hexyl, particularly preferably C₁-C₄-alkyl, such as methyl, ethyl, n-propyl, isopropyl, n-butyl, isobutyl, sec-butyl or tert-butyl;
   C₂-C₂₀-hydroxyalkyl, for example 2-hydroxy-n-propyl, preferably ω-C₂-C₂₀-hydroxyalkyl, such as 2-hydroxyethyl, 2-hydroxy-n-propyl, 3-hydroxypropyl, 4-hydroxy-n-butyl, 6-hydroxy-n-hexyl, ω-hydroxydecyl, ω-hydroxy-n-dodecyl, ω-hydroxy-n-hexadecyl or ω-hydroxyeicosyl;
   C₆-C₁₄-aryl, for example phenyl, α-naphthyl, β-naphthyl or 9-anthracenyl, in particular phenyl;

C₁-C₆-alkoxy, for example methoxy, ethoxy, n-propoxy, isopropoxy, n-butoxy, isobutoxy, sec-butoxy, tert-butoxy, n-pentyloxy, isopentyloxy, n-hexyloxy or isohexyloxy, particularly preferably methoxy, ethoxy, n-propoxy or n-butoxy;
carboxylic esters, for example COOCH₃, COOC₂H₅, COO-n-C₃H₇, COO-iso-C₃H₇, COO-n-C₄H₉, COO-iso-C₄H₉, COO-tert-C₄H₉, COO—CH₂CH (C₂H₅) (C₄H₉), COO—CH₂CH₂OH, COO—CH₂—CH₂—CH₂—OH COO—(CH₂)₄—OH, COO—(CH₂)₆—OH, COO(CH₂—CH₂—O)ᵣ—H or COO(CHCH₃—CH₂—O)ᵣ—H, where r is an integer from 1 to 100, preferably from 2 to 50;
carboxamides CO—NR³R⁴, CO—NR³R⁴CH₃⁺ or CO—NR³R⁴C₂H₅⁺;
groups of the formula CO—Y¹—(CH₂)ₘ—NR³R⁴, CO—Y¹—(CH₂)ₘ—NR³R⁴CH₃⁺ or CO—Y¹—(CH₂)ₘ—NR³R⁴C₂H₅⁺, where m is an integer from 0 to 4, preferably 2 or 3, and Y¹ is oxygen or N—H, and the positive charges occurring in the groups of the formulae CO—NR³R⁴CH₃⁺, CO—NR³R⁴C₂H₅⁺, CO—Y¹—(CH₂)ₘ—NR³R⁴CH₃⁺ and CO—Y¹—(CH₂)ₘ—NR³R⁴C₂H₅⁺ being compensated by opposite ions, for example Cl⁻ or CH₃SO₄−;
R² is hydrogen,
   C₁-C₂₀-alkyl, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl, n-decyl, n-dodecyl, n-hexadecyl or n-eicosyl; preferably C₁-C₆-alkyl, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl or sec-hexyl, particularly preferably C₁-C₄-alkyl, for example methyl, ethyl, n-propyl, isopropyl, n-butyl, isobutyl, sec-butyl or tert-butyl;
   C₃-C₁₂-cycloalkyl, for example cyclopropyl, cyclobutyl, cyclopentyl, cyclohexyl, cycloheptyl, cyclooctyl, cyclononyl, cyclodecyl, cycloundecyl or cyclododecyl; preferably cyclopentyl, cyclohexyl or cycloheptyl;
   C₇-C₁₃-aralkyl, preferably C₇- to C₁₂-phenylalkyl, for example benzyl, 1-phenethyl, 2-phenethyl, 1-phenylpropyl, 2-phenylpropyl, 3-phenylpropyl, neophyl (1-methyl-1-phenylethyl), 1-phenylbutyl, 2-phenylbutyl, 3-phenylbutyl or 4-phenylbutyl, particularly preferably benzyl;
   C₆-C₁₄-aryl, for example phenyl, 1-naphthyl, 2-naphthyl, 1-anthryl, 2-anthryl, 9-anthryl, 1-phenanthryl, 2-phenanthryl, 3-phenanthryl, 4-phenanthryl or 9-phenanthryl, preferably phenyl, 1-naphthyl or 2-naphthyl, particularly preferably phenyl;
   C₂-C₂₀-hydroxyalkyl, for example 2-hydroxy-n-propyl, preferably ω-C₂-C₂₀-hydroxyalkyl, for example 2-hydroxyethyl, 2-hydroxy-n-propyl, 3-hydroxypropyl, 4-hydroxy-n-butyl, 6-hydroxy-n-hexyl, ω-hydroxydecyl, ω-hydroxy-n-dodecyl, ω-hydroxy-n-hexadecyl or ω-hydroxyeicosyl, very particularly preferably 2-hydroxyethyl; and
R³ and R⁴, independently of one another, are hydrogen or C₁-C₄-alkyl, for example methyl, ethyl, n-propyl, isopropyl, n-butyl, isobutyl, sec-butyl or tert-butyl.
A² are ionic or ionizable groups, preferably —N(R²)—, —CO—N(R²)—, —N⁺ (R²)₂— or —CO—N⁺ (R²)₂—, where R² is as above but, in the special meaning, is defined independently thereof,
M is hydrogen, alkali metal ions, for example Li⁺, Na⁺, K⁺, Rb⁺ or Cs⁺ or a mixture thereof, preferably Na⁺ or K⁺;
   ammonium ions of the formula N(R⁵)₄⁺, where the radicals R⁵, independently of one another, are:
   C₁-C₂₀-alkyl, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl, n-decyl, n-dodecyl, n-hexadecyl or n-eicosyl; preferably C₁-C₆-alkyl, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, or sec-hexyl, particularly preferably C₁-C₄-alkyl, for example methyl, ethyl, n-propyl, isopropyl, n-butyl, isobutyl, sec-butyl or tert-butyl;
   C₃-C₁₂-cycloalkyl, for example cyclopropyl, cyclobutyl, cyclopentyl, cyclohexyl, cycloheptyl, cyclooctyl, cyclononyl, cyclodecyl, cycloundecyl or cyclododecyl; preferably cyclopentyl, cyclohexyl or cycloheptyl;
   C₇-C₁₃-aralkyl, preferably C₇- to C₁₂-phenylalkyl, for example benzyl, 1-phenethyl, 2-phenethyl, 1-phenylpropyl, 2-phenylpropyl, 3-phenylpropyl, neophyl (1-methyl-1-phenylethyl), 1-phenylbutyl, 2-phenylbutyl, 3-phenylbutyl or 4-phenylbutyl, particularly preferably benzyl;
   C₆-C₁₄-aryl, for example phenyl, 1-naphthyl, 2-naphthyl, 1-anthryl, 2-anthryl, 9-anthryl, 1-phenanthryl, 2-phenanthryl, 3-phenanthryl, 4-phenanthryl or 9-phenanthryl, preferably phenyl, 1-naphthyl or 2-naphthyl, particularly preferably phenyl;
   C₂-C₂₀-hydroxyalkyl, for example 2-hydroxy-n-propyl preferably ω-C₂-C₂₀-hydroxyalkyl, for example 2-hydroxyethyl, 2-hydroxy-n-propyl, 3-hydroxypropyl, 4-hydroxy-n-butyl, 6-hydroxy-n-hexyl, ω-hydroxydecyl, ω-hydroxy-n-dodecyl, ω-hydroxy-n-hexadecyl or ω-hydroxy-eicosyl, very particularly preferably 2-hydroxyethyl; and
   in particular hydrogen.

Mixtures of the abovementioned ions can also be chosen.

Anions, for example halide, preferably chloride or bromide, and sulfate, hydrogen sulfate, phosphate, hydrogen phosphate or dihydrogen phosphate, serve for saturating the positive charges in the polyelectrolytes used.

In on average at least one repeating unit per molecule, R² is not hydrogen, i.e. at least one nitrogen atom is completely alkylated, arylated or aralkylated.

In a preferred embodiment, repeating units A.3 of the polyelectrolytes used according to the invention are such that A¹ is COOH and A¹* is COO(CH₂—CH₂—O)ᵣ—H.

Preferably, at least 15 mol % of the repeating units A¹ in formula A.1 or A.3 are selected from COOH or COOM groups, and M is defined as above.

In each case, two of the radicals A¹ and A¹* can be linked to one another to form a divalent ring system having 1 to 20 ring members, for example in the manner of the following formula A.14 (three ring members):

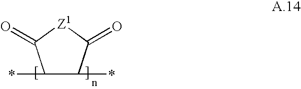

In formula A.14, Z¹ is a divalent group, for example CH₂, O or NH, N—C₁-C₂₀-alkyl or N⁻, the negative charge being saturated by one or more of the abovementioned cations and the alkyl radicals being defined as above.

The organic polyelectrolytes used in process step A) of the novel process preferably contain carboxyl groups, it being possible for the carboxyl groups to be present as free acids or completely or in a certain percentage as salt, i.e. in neutralized form. It is preferable if a certain percentage of the carboxyl groups have been neutralized. For example, from 20 to 99, particularly preferably from 50 to 95, mol % of neutralized carboxyl groups are suitable.

Very particularly preferably used organic polyelectrolytes are those high molecular weight compounds which are prepared from at least 60 mol % of the monomers acrylic acid, methacrylic acid and maleic acid or mixtures thereof and the relevant salts. These include in particular polyacrylates or polyacrylic acid/maleic anhydride copolymers having a molar maleic anhydride content of from 1 to 40%, especially from 1 to 15%.

In order to obtain the organic polyelectrolytes used in process step A) of the novel process and known per se, polymers or copolymers which are composed of one or more known olefinically unsaturated monomers are synthesized by known processes. Preferred monomers which, in the polymerization, give the polyelectrolytes used according to the invention are olefinically unsaturated monobasic or polybasic carboxylic acids. Acrylic acid, methacrylic acid, crotonic acid, fumaric acid and maleic acid are particularly preferred and acrylic acid, methacrylic acid and maleic acid are very particularly preferred. Acrylic acid, methacrylic acid and maleic acid can also be readily used in the form of the anhydride in the polymerization. All monomers can be used in the polymerization as free acids, as salt in neutralized form corresponding to the above definition and also as a mixture of free acid and salt. The polyelectrolytes are synthesized by processes known per se. The polymerization is preferably effected by a free radical method, as described, for example, in DE-A 31 38 574.

Comonomers may also be used in the polymerization. Suitable comonomers are, for example,
vinyl ethers, such as methyl vinyl ether, ethyl vinyl ether, vinyl n-propyl ether, vinyl isopropyl ether, n-butyl vinyl ether, vinyl isobutyl ether or vinyl tert-butyl ether,
(meth)acrylic acid derivatives, such as methyl acrylate, methyl methacrylate, ethyl acrylate, ethyl methacrylate, acrylamide, methacrylamide, tert-butylacrylamide, tert-butyl acrylate, tert-butyl methacrylate or acrylonitrile,
olefins, such as ethylene, propylene, 1-butene, 1-pentene, 1-hexene, 1-octene, 1-decen, 1,3-butadiene, isobutene, isoprene, vinyl chloride or vinylidene chloride,
vinylaromatics, such as styrene or α-methylstyrene,
maleimide or N-methylmaleimide.
Mixtures of the abovementioned comonomers are furthermore suitable.

The use of organic polyelectrolytes which contain monomers having hydrolyzable units, for example of A.5.a or A.5.b, is also considered to be according to the invention when the hydrolyzable units have been completely or partially hydrolyzed.

The organic polyelectrolytes used in process step A) of the novel process have a number average molecular weight of from 500 to 150 000 g, preferably from 1 000 to 70 000 g, particularly preferably up to 10 000 g. The width of the molecular weight distribution M_{w}/Mₙ, is from 1.2 to 50, preferably from 1.5 to 15, particularly preferably from 2 to 15.

The organic polyelectrolytes used in process step A) of the novel process carry on average at least repeating units A.1 to A.4 per molecule, it being possible for these groups or repeating units to be identical or different. Preferably, the polyelectrolytes used according to the invention carry on average at least 4, particularly preferably at least 5, groups of the formulae A.1 to A.4.

Suitable inorganic polyelectrolytes for the novel process are polyphosphates, preferably in the form of their alkali metal salts, in particular the sodium or potassium salts, and soda or potassium waterglasses. Furthermore, the inorganic polyelectrolytes to be used according to the invention are also to be understood as meaning aluminosilicates, in particular those of the alkali metals and alkaline earth metals. In particular, members of the group consisting of the phyllosilicates, for example kaolinite, the dioctahedral smectites, in particular muscovite and montmorillionite (main component of bentonites) and the trioctahedral smectites, in particular hectorite, may be mentioned here. In this context, reference may also be made to the prior German Patent Application 102 37 259.4.

The polyelectrolytes described can be used at different stages in process step A) of the novel process for the production of semifinished products and intermediate products in leather production or in the production of skins.

Preferably, the polyelectrolytes described above are used during liming, before or during deliming, before or during bating or before or during pickling.

A particular aspect of the present invention in process step A) of the novel process is the use of the polyelectrolytes described above during liming (step a)) and a further aspect of the present invention is a process for treating the hides by using the polyelectrolytes described above during liming.

Below, data in % by weight are based on the salted weight, unless stated otherwise.

For the use of the polyelectrolytes described above during liming, it is expedient substantially to markedly reduce the amount of lime and instead to add an inorganic basic alkali metal compound, for example a hydroxide or a carbonate of an alkali metal, preferably of sodium or potassium, very particularly preferably of sodium, and one or more of the polyelectrolytes described above. Other suitable inorganic basic alkali metal compounds are alkali metal silicates.

A preferred variant in process step A) of the novel process comprises reducing the amount of lime used during liming to 0.1 to 1.5, particularly preferably 0.01 to 0.5, % by weight. In another particularly preferred variant, the use of lime is completely dispensed with.

According to the invention, from 0.001 to 100, preferably from 0.005 to 50, particularly preferably from 0.03 to 10, very particularly preferably from 0.1 to 5, % by weight of one or more polyelectrolytes are added.

The polyelectrolyte or polyelectrolytes can be added individually or together with the inorganic basic alkali metal compound or compounds. Furthermore, the addition of one or more polyelectrolytes and of the inorganic basic alkali metal compound or compounds can be effected in each case in one portion or in a plurality of portions and in each case before or during liming.

The addition immediately at the beginning of liming is preferred. The invention should also comprise adding, for example, a portion of polyelectrolyte immediately before liming or during or at the end of soaking and a further portion—together with the inorganic basic alkali metal compound or compounds—during liming. If it is desired to carry out the addition of the polyelectrolyte or polyelectrolytes in a plurality of portions, the ratio of polyelectrolyte in the individual portions is not critical. It has proven expedient to choose portions of about the same size. Another conceivable variant is to add from 1.1 to 10 times as much polyelectrolyte in the first portion as in the second one; another conceivable variant is to add from 1.1 to 10 times as much polyelectrolyte in the second portion as in the first one. Analogously, the amount of the inorganic basic alkali metal compound or compounds to be added can be distributed over a plurality of portions.

In a further variant of process step A) of the novel process, the polyelectrolytes are modified in situ; for example, polyacrylates or polymethacrylates can be used as polymeric acids and can be converted into the poly-alkali metal salt of the relevant polyelectrolyte by the basic alkali metal compound used.

According to the invention, the polyelectrolyte or polyelectrolytes can be added in the absence of a solvent or in solution, preferably in aqueous solution.

In a preferred variant of the novel process, one or more amine compound, in particular one or more hydroxylamine compounds or hydrazine compounds of the formula A.15.a, A.15.b 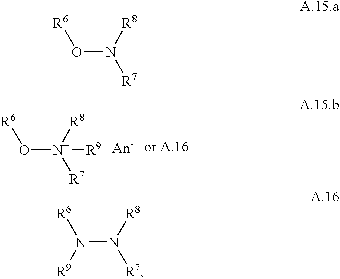
where:
R⁶ to R⁹, independently of one another, are hydrogen, C₁-C₂₀-alkyl or C₆-C₁₄-aryl, the alkyl and aryl radicals corresponding to the meanings mentioned and exemplified under R¹, and
An⁻ is halide, sulfate, hydrogen sulfate, phosphate, hydrogen phosphate or dihydrogen phosphate or a mixture of said anions
are added in addition to the electrolytes described above during liming (step (a) of process step A)).

In particular, those compounds of the formulae A.15.a and A.15.b in which at least one of the radicals R⁶ to R⁹ is hydrogen are used.

Examples of anions An⁻ are halide, preferably chloride or bromide, and furthermore sulfate, hydrogen sulfate, phosphate, hydrogen phosphate and/or dihydrogen phosphate.

The use of hydroxylamine compounds of the formula A.15.a is preferred. The use of hydroxylamine in the form of the free base is very particularly preferred.

If one or more hydroxylamine compounds of the formula A.15.a are used, the amount of basic alkali metal compound can be reduced.

It is particularly advantageous to use one or more hydroxylamine compounds of the formula A.15.a or A.15.b or one or more hydrazine compounds of the formula A.16 together with alkali metal hydroxide and alkali metal carbonate in addition to the polyelectrolyte during liming (step (a) of process step A)).

The amount of hydroxylamine compounds of the formula A.15.a or A.15.b or one or more hydrazine compounds of the formula A.16 which is preferably used during liming is from 0.5 to 10% by weight.

Of course, assistants customary in tanning, for example biocides, enzymes, unhairing agents, surfactants and emulsifiers, may also be added to the solution of the polyelectrolyte.

A further aspect of the present invention, in process step A) of the novel process, is the addition of one or more of the polyelectrolytes described above before or during deliming. According to the invention, from 0.001 to 100, preferably from 0.005 to 50, particularly preferably from 0.03 to 10, very particularly preferably from 0.1 to 5, % by weight of one or more polyelectrolytes are added.

A further aspect of the present invention, in process step A) of the novel process, is the addition of one or more of the polyelectrolytes described above before or during bating. According to the invention, from 0.001 to 100, preferably from 0.005 to 50, particularly preferably from 0.03 to 10, very particularly preferably from 0.1 to 5, % by weight of one or more polyelectrolytes are added.

A further particular aspect of the present invention, in process step A) of the novel process, is the use of the polyelectrolytes described above before or during pickling, preferably immediately before pickling, and a further aspect of the present invention is a process for treating hides by using the polyelectrolytes described above before or during pickling.

For the use of the polyelectrolytes described above before or during pickling in process step A) of the novel process, the amount (usually from 5 to 10% by weight) of alkali metal halide used, usually sodium chloride, may expediently be reduced and instead a novel amount of one or more polyelectrolytes may be used.

According to the invention, from 0.001 to 100, preferably from 0.005 to 50, particularly preferably from 0.03 to 10, very particularly preferably from 0.1 to 5, % by weight of one or more polyelectrolytes are used.

According to the invention, furthermore from 0 to 3, preferably from 0 to 1, particularly preferably from 0 to 0.5, % by weight of one or more inorganic alkali metal or alkaline earth metal salts, for example alkali metal halides, such as sodium fluoride, sodium chloride, sodium bromide, potassium chloride or potassium bromide or mixtures thereof, are used before or during pickling, preferably immediately before pickling in process step A) of the novel process. It is also possible to add other inorganic alkali metal salts, for example Glauber's salt (sodium sulfate), or inorganic alkaline earth metal salts, such as magnesium chloride or magnesium sulfate. In a very particularly preferred variant, at least 0.01 to 0.2% by weight of inorganic alkali metal or alkaline earth metal salts, in particular sodium chloride, is used; in another very particularly preferred variant, the use of alkali metal or alkaline earth metal salts is completely dispensed with. Very particularly preferably, not more than 0.05% by weight of alkali metal halide, in particular sodium chloride, is used.

The addition of one or more polyelectrolytes and alkali metal or alkaline earth metal salts in process step A) of the novel process, if an addition of alkali metal or alkaline earth metal salts is desired, can be effected separately or together and in each case immediately before or during pickling. Furthermore, the addition of one or more polyelectrolytes and—if desired—alkali metal or alkaline earth metal salts can be effected in each case in one portion of in a plurality of portions and in each case before or during pickling. It is also according to the invention, for example, to add a portion of polyelectrolyte immediately before pickling and a further portion—together with alkali metal or alkaline earth metal salt—during pickling. If it is desired to carry out the addition of the polyelectrolyte or polyelectrolytes in a plurality of portions, the ratio of polyelectrolyte in the individual portions is not critical. It has proven expedient to choose portions of about the same size. Another conceivable variant comprises adding from 1.1 to 10 times as much polyelectrolyte in the first portion as in the second one; another conceivable variant comprises adding from 1.1 to 10 times as much polyelectrolyte in the second portion as in the first one. Analogously, the amount of the alkali metal or alkaline earth metal salts to be added can be distributed over a plurality of portions.

The polyelectrolyte or polyelectrolytes can be added in process step A) of the novel process in the absence of a solvent or in solution, preferably in aqueous solution, it being possible also to add assistants customary in tanning, for example biocides, acids, such as sulfuric acid, formic acid, hydrochloric acid, oxalic acid or acetic acid, acidic salts, buffers, fatliquoring agents, resin tanning agents, vegetable tanning agents and fillers, for example kaolin or ligninsulfonate, to the solution.

The residence time of the unsplit hides in the pickle in process step A) of the novel process is usually from 10 minutes to 24 hours, preferably from 15 minutes to 2 hours, particularly preferably from 15 to 45 minutes. With the use of split hides, shorter residence times are possible, as is known to a person skilled in the art.

The pickling takes place under conditions otherwise customary in tanning, the temperature is from 10 to 35° C. and the pressure is from 1 to 10 bar, atmospheric pressure being particularly expedient.

If, according to the invention, one or more polyelectrolytes are added in process step A) of the novel process before or during liming, the amount of added polyelectrolyte in the pickle can be reduced. In an extreme case, the addition of further polyelectrolyte during or immediately before pickling can be completely dispensed with.

In a particular variant, in process step A) of the novel process, from 0.1 to 10, preferably from 0.5 to 10, % by weight of one or more polyelectrolytes are added during liming, and the addition of further polyelectrolyte can be dispensed with in the further steps, deliming, bating and pickling, because the concentration of polyelectrolyte is sufficiently high. In a preferred variant of the novel process, in which the addition of lime is completely dispensed with, it is possible to dispense with a separate deliming step; particularly in this variant, a further addition of polyelectrolyte can be dispensed with.

Process step B) of the present invention comprises the unhairing of the hides with one or more compounds of the formula B.1 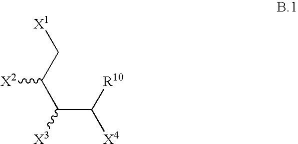
or the corresponding alkali metal, alkaline earth metal, ammonium or phosphonium salts thereof,
with the proviso that at least two mercapto groups are contained in the compound or compounds B.1,
where:
R¹⁰ is hydrogen or C₁-C₁₂-alkyl which is unsubstituted or substituted by one or more mercapto or hydroxyl groups, for example
   methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl or n-decyl, particularly preferably C₁-C₄-alkyl, such as methyl, ethyl, n-propyl, isopropyl, n-butyl, isobutyl, sec-butyl and tert-butyl;
   hydroxymethyl, 2-hydroxyethyl, 1,2-dihydroxyethyl, 3-hydroxy-n-propyl, 2-hydroxyisopropyl, ω-hydroxy-n-butyl, ω-hydroxy-n-decyl, HS—CH₂—, HS—(CH₂)₂— or HS—(CH₂)₃—;
   in particular hydrogen;
X¹ to X⁴, independently of one another, are hydrogen;
   C₁-C₄-alkyl, for example methyl, ethyl, n-propyl, isopropyl, n-butyl, isobutyl, sec-butyl or tert-butyl;
   hydroxyl, mercapto or NHR¹¹, in particular hydroxyl or mercapto; and
R¹¹ is hydrogen, formyl,
   C₁-C₁₂-alkyl, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl or n-decyl, particularly preferably C₁-C₄-alkyl, such as methyl, ethyl, n-propyl, isopropyl, n-butyl, isobutyl, sec-butyl or tert-butyl; or
   C₁-C₄-alkylcarbonyl, for example acetyl, C₂H₅—C═O, n-C₃H₇—C═O, iso-C₃H₇—C═O, n-C₄H₉—C═O, iso-C₄H₉—C═O, sec-C₄H₉—C═O or tert-C₄H₉—C═O.

Preferably at least one group X¹ to X⁴ is a hydroxyl group, particularly preferably at least two groups X¹ to X⁴ are hydroxyl groups.

Examples of the corresponding alkali metal and alkaline earth metal salts are in particular the mono- and disodium salts, mono- and dipotassium salts and potassium sodium salts of the compounds of the formula B.1, and furthermore the corresponding calcium and magnesium salts. Further examples are the ammonium salts and primary, secondary, tertiary and in particular quaternary mono- and diammonium salts and phosphonium salts. Of course, mixtures of compounds of the formula B.1 and the corresponding alkali metal or alkaline earth metal salts or ammonium or phosphonium salts thereof may also be used. The alkali metal salts are preferably used.

Preferred mono- and diammonium salts have, as cations, those of the formula N(R¹²) (R¹³) (R¹⁴) (R¹⁵)⁺, where R¹² to R¹⁵, in each case independently of one another, are hydrogen, C¹-C₁₂-alkyl, phenyl or CH₂—CH₂—OH. Examples are tetramethylammonium, tetraethylammonium, methyldiethanolammonium and n-butyldiethanolammonium. Preferred mono- and diphosphonium salts have, as cations, those of the formula P(R¹²) (R¹³) (R¹⁴) (R¹⁵)⁺, where R¹² to R¹⁵ are defined as above.

Very particularly preferably, one or more 1,4-dimercaptobutanediols of the formulae B.1.a, B.1.a′ and B.1.b 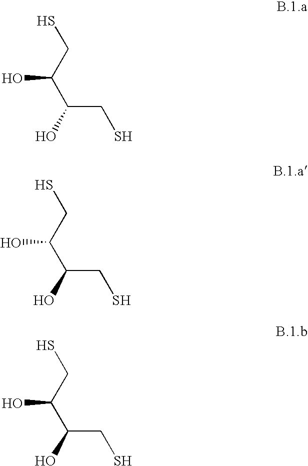
or the corresponding alkali metal or alkaline earth metal salts thereof are used in process step B) of the novel process. B.1.a and B.1.a′ are also referred to as dithiothreitol, and B.1.b also as dithioerythrol. The use of racemic dithiothreitol is very particularly preferred. B.1.a, B.1.a′ and B.1.b are virtually odorless, readily meterable and readily water-soluble compounds.

The compounds B.1.a or B.1.a′ and B.1.b are known and are commercially available, for example, from Aldrich or AGROS Chemicals. Further members can be synthesized as described in U.S. Pat. No. 4,472,569 or in J. Chem. Soc. 1949, 248 or by analogous reactions.

In general, an amount of from 0.1 to 5, preferably from 0.5 to 2.5, particularly preferably from 0.75 to 1.5, % by weight, based on the hide weight or salt weight of the hides, furs or skins, of compound B.1 are sufficient in process step B) of the novel process.

In process step B) of the novel process, the hides, furs or skins are preferably treated with one or more compounds of the formula B.1 during liming or during sulfiding, in particular under either hair-destroying or hair-preserving conditions. This makes it possible to manage with a concentration of less than 1% by weight of Na₂S or NaHS with an equally large effect with regard to the removal of horny substances during liming or sulfiding, instead of the usual concentration of about 4% by weight of Na₂S or NaHS or even slightly more.

In one variant of process step B) of the novel process, one or more compounds of the formula B.1 can be used together with thiols known from tanning, for example mercaptoethanol or thioglycolic acid, during liming. Preferably, less than 0.5% by weight of mercaptoethanol or thioglycolic acid is used here.

However, the use of Na₂S or NaHS or other foul-smelling sulfur-containing reagents is preferably dispensed with in process step B) of the novel process.

The hides are treated in process step B) of the novel process in an aqueous liquor. The liquor ratio is from 1:10 to 10:1, preferably from 1:2 to 4:1, particularly preferably up to 3:1, based on the hide weight or salt weight of the hides.

Process step B) of the novel process is carried out at a pH of from 7 to 14, preferably from 8 to 13, particularly preferably from 9 to 12.5.

The pH can be established by adding up to 3% by weight, based on the liquor, of lime. However, the amount of lime can also be substantially reduced. In a preferred variant of the novel process, the use of lime is dispensed with. In the preferred embodiment, one or more inorganic basic alkali metal compounds, for example one or more hydroxides or carbonates of alkali metals, preferably of sodium or potassium, very particularly preferably of sodium, are added. Other suitable inorganic basic alkali metal compounds are alkali metal silicates. Basic amines, for example ammonia, methylamine, dimethylamine, ethylamine or triethylamine, or combinations of alkali metal compound and one or more basic amines, may also be added.

In addition to water, further organic solvents may be present in the liquor, for example up to 20% by volume of ethanol or isopropanol.

Process step B) of the novel process can be carried out in the vessels which are customary in tanning and in which liming is usually effected. The novel process is preferably carried out in rotatable drums with internal fittings. The speed is usually from 0.5 to 100/min, preferably from 1.5 to 10/min, particularly preferably from 2 to 6/min.

The pressure and temperature conditions for carrying out process step B) of the novel process are generally not critical. The procedure at atmospheric pressure has proven suitable; a pressure increased to 10 bar is also conceivable. Suitable temperatures are from 10 to 45° C., preferably from 15 to 35° C., particularly preferably from 20 to 30° C.

The compound or compounds of the formula B.1 can be metered at the beginning of the liming process, but it is also possible for the hides first to be softened under basic conditions and one or more compounds of the formula B.1 to be metered only after some time. The metering can be effected in one step, i.e. the total amount of the compound or compounds B.1 used is metered in one step; however, B.1 can also be metered in portions or continuously.

Process step B) of the novel process can be carried out in a period of from 10 minutes to 48 hours, preferably from 1 to 36 hours, particularly preferably from 3 to 15 hours.

Of course, assistants customary in tanning, for example phosphines, such as triphenylphosphine or tris(2-carboxyethyl)phosphine hydrochloride, and furthermore hydroxylamine, urea, guanidine or guanidine hydrochloride, hydrazine, biocides, enzymes, surfactants and emulsifiers, can be added for carrying out process step B) of the novel process.

Pelts unhaired in an excellent manner can be produced by process step B) of the novel process. Surprisingly, it is also found that the epidermis is completely or at least substantially detached after only a short treatment time.

According to the invention, degreasing agents of the formula C.1 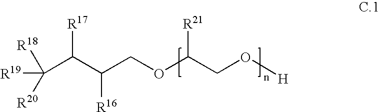
are used in process step C) for degreasing pelts, hides or further intermediate products and semifinished products in leather production. In formula C.1, the variables are defined as follows:
R¹⁶ to R¹⁹, independently of one another, are hydrogen or
   C₁-C₁₀-alkyl, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl or n-decyl; preferably C₁-C₆-alkyl, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl or sec-hexyl, particularly preferably C₁-C₄-alkyl, for example methyl, ethyl, n-propyl, isopropyl, n-butyl, isobutyl, sec-butyl or tert-butyl;
R²⁰ is hydrogen or
   C₁-C₂₅-alkyl, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl, n-decyl, n-dodecyl, n-hexadecyl or n-eicosyl; preferably C₁-C₆-alkyl, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl or sec-hexyl, particularly preferably C₁-C₄-alkyl, for example methyl, ethyl, n-propyl, isopropyl, n-butyl, isobutyl, sec-butyl or tert-butyl;
R²¹ is hydrogen or
   C₁-C₄-alkyl, for example methyl, ethyl, n-propyl, isopropyl, n-butyl, sec-butyl, isobutyl or tert-butyl;
   R¹⁶ being selected from C₁-C₁₀-alkyl when R¹⁸ to R²⁰ are each hydrogen
   and at least one radical from among R¹⁸ to R²⁰ being selected from C₁-C₂₅-alkyl when R¹⁶ is hydrogen,
n is an integer from 1 to 100, preferably from 1 to 25, particularly preferably from 3 to 15.

The degreasing agent used in process step C) of the novel process has very good efficiency in the emulsifier degreasing. Particularly in an aqueous medium, it has a good emulsifying effect on natural fats and oils and emulsifies them in such a way that the fat and oil components can be readily washed out of the animal hide with water.

The degreasing agent used in process step C) of the novel process preferably contains a mixture of alcohol alkoxylates, based on from 1 to 3 different alcohols C.2 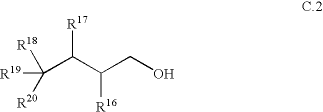
particularly preferably on a single alcohol C.2 or two different alcohols C.2. If mixtures of degreasing agents based on different alcohols C.2 are employed, the number of carbon atoms of the alcohol radical and/or the type of branching may differ.

The main chain of the alcohols C.2 preferably has from one to 4, particularly preferably from 1 to 3, branches, provided that the chain length permits more than one branch in the middle of the chain. These branches, independently of one another, generally have 1 to 10, preferably 1 to 6, particularly preferably 2 to 4, very particularly preferably 2 or 3, carbon atoms. Particularly preferred branches are accordingly ethyl, n-propyl or isopropyl groups.

The radical of the alcohol C.2 has 5 to 30 carbon atoms. Since C.2 has at least one branch with at least one carbon atom, the main chain comprises 4 to 29 carbon atoms. Preferably, C.2 has up to 25 carbon atoms, particularly preferably 10 to 20, carbon atoms. This means that the main chain has preferably 5 to 24, particularly preferably 9 to 19, carbon atoms. Very particularly preferably, the main chain has 9 to 15 carbon atoms and the other carbon atoms of C.2 are distributed over one or more branches.

The preparation of the branched alcohols C.2 which are required for the preparation of the alcohol alkoxylates used in process step C) of the novel process is effected by methods known to a person skilled in the art. A general synthesis route for the preparation of branched alcohols is, for example, the reaction of aldehydes or ketones by the Guerbet reaction or using Grignard reagents. Instead of the Grignard reagents, aryl- or alkyllithium compounds, which have higher reactivity, may also be used.

The alcohol alkoxylates used, which are contained in the degreasing agents used in process step C) of the novel process, are based on the reaction products of branched alcohols C.2 with alkylene oxide which is preferably selected from the group consisting of ethylene oxide, propylene oxide and butylene oxide. It is possible to react a single alcohol C.2 with different alkylene oxides from among the stated alkylene oxides, e.g. ethylene oxide and propylene oxide, it being possible to obtain alcohol alkoxylates which in each case have blocks of a plurality of units of an alkylene oxide, e.g. ethylene oxide, in addition to blocks of a plurality of units of a further alkylene oxide, e.g. propylene oxide.

The amounts of alkylene oxide used are from 1 to 100, preferably from 1 to 25, particularly preferably from 3 to 15, very particularly preferably from 5 to 12, mol of alkylene oxide per mole of alcohol. In the alcohol alkoxylates used according to the invention, the degree of alkoxylation achieved has a broad distribution and, depending on the amount of alkylene oxide used, may be from 0 to 100 mol of alkylene oxide per mole of alcohol. It has been found that the molecular weight distribution which is achieved by reacting the alcohols C.2 used with alkylene oxides and which is based on the degree of alkoxylation of the alcohols does not correspond to a Gaussian distribution. Such a Gaussian distribution is obtained in the case of alkoxylation of oxo alcohols (industrial alcohols which contain about 60% by weight of linear alcohols and about 40% by weight of alcohols branched with methyl groups) to give alcohol alkoxylates as used in the prior art in leather degreasing agents, and in the case of alkoxylation of alkylphenols, the alkoxylation products of which have been the most successful to date in the degreasing of leather. The degree of alkoxylation and hence the molecular weight distribution is substantially broader in the case of alkoxylation of the alcohols C.2 used in process step C) of the novel process.

If the degreasing agent used in process step C) of the novel process contains a mixture of alcohol alkoxylates which are based on different alcohols and/or have been reacted with a different amount or different alkylene oxides, these may be present in any desired ratios. If the degreasing agent contains, for example, two different alcohol alkoxylates, they may be present in ratios of from 20:1 to 1:1, preferably from 9:1 to 1:1. In the case of three different alcohol alkoxylates, it is also possible for one of the components to be present in excess relative to the other two components. It is also possible for 2 components to form the main part of the alcohol alkoxylates and for only small amounts of the third component to be present. Furthermore, it is possible for all three components to be contained in the degreasing agent in about the same amounts.

The HLB values of the alcohol alkoxylates used as degreasing agents in process step C) of the novel process are in general from 8 to 16, preferably from 9 to 14.

The alcohol alkoxylates are prepared from the branched alcohols C.2 by reaction with alkylene oxides. The reaction conditions are known to a person skilled in the art. In general, the reaction is carried out over an alkali metal catalyst. Usually, NaOH or KOH is used. It is also possible to use Ca(OH)₂, Ba(OH)₂, Sr(OH)₂ or hydrotalcite as catalysts. Furthermore, complex metal cyanides, e.g. Zn₃[Co(CN)₆]₂ can also be used as catalysts. The latter catalysts lead as a rule to narrower molecular weight distributions. The reaction is preferably effected in the absence of water. The reaction temperature is in general from 70 to 180° C.

The novel degreasing agents can be used in different process stages in which the use of a degreasing agent is expedient or necessary, in leather or fur production. Thus, it can be used, for example, in soaking, liming, deliming, bating, pickling and/or tanning and after depickling, in the processing of wet blue or wet white, in the wet finishing process and in the working-up of crust leathers. These individual process stages are known to a person skilled in the art.

Depending on the process stage in which the novel degreasing agents are employed, the degreasing agents can be used in combination with further components. Such components are known to a person skilled in the art. Suitable components are, for example, further formulation agents, such as wetting agents, raw components having a surfactant effect, e.g. ether sulfates or dispersants; antifoams, such as paraffins and siloxanes; carrier oils, such as higher alkanes, aromatics-rich vegetable or synthetic oils, white oil or mineral oil; other nonionic, anionic, cationic and/or amphoteric surfactants.

Process step C) of the novel process can be carried out in the liquor or without a liquor. If the process is carried out without a liquor, the novel degreasing agent is added to the hides, skins, pelts or further intermediate products to be degreased, and this is followed by milling.

The exact process conditions are dependent on the process stage in which the degreasing agent used in process step C) of the novel process is used. The following data are therefore general process conditions, without any detailed discussion of the specific special features, which are to be taken into account in the individual process stages. These are known to a person skilled in the art.

The alcohol alkoxylates contained in the degreasing agent used in process step C) of the novel process are used in general in an amount of from 0.5 to 5, preferably from 1 to 3, % by weight, based on the weight of the hides, skins, pelts or other intermediate products, in leather and fur production. These data relate to the total content of the alcohol alkoxylates contained in the degreasing agent used in process step C) of the novel process. With the use of a plurality of alcohol alkoxylates, the proportion of the individual alcohol alkoxylates is obtained from the abovementioned ratios. The degree of degreasing generally increases with the amount used, up to the stated upper limit, the degree of degreasing depending, inter alia, on the natural fat content of the animal hides. An addition of larger amounts of alcohol alkoxylates is not expedient since no further improvement in the degree of degreasing is achieved or the quality may be impaired. Furthermore, it should be ensured that the saturation concentration of the alcohol alkoxylate used is not exceeded.

The novel process is carried out in general at a pH of from 2 to 10. The pH varies from acidic to basic depending on the process stage. The effect of the pH on the degree of degreasing is generally small in the case of the nonionic surfactants used according to the invention.

The salt contents present during the degreasing process correspond to the salt contents usually used in the various process stages. The salt content of the liquor may be in general from 0 to 100, preferably from 0 to 3, g of NaCl/l.

The temperature when carrying out the novel process is in general from 15 to 65° C., preferably from 20 to 55° C., in particular from 28 to 40° C.; it must however be at least 5° C. below the melting point of collagen. The temperature may also differ in the different process stages. Thus, higher temperatures can be used after the tanning of the leather than in the preceding steps since temperatures which are too high prior to tanning can adversely affect the quality of the leathers or skins to be produced. An increase in the temperature generally leads to an increase in the degree of degreasing.

The duration of the process in turn depends on the process stage in which the novel degreasing agent is used. In general, the duration of the degreasing is from 0.5 to 10, preferably from 0.5 to 5, particularly preferably from 0.5 to 3, hours. The degree of degreasing generally increases with increasing duration, until a maximum is reached.

The liquor length should be chosen at least sufficiently long for micelle formation to be present, so that the degreasing agent can display its effect. For good efficiencies, a plurality of liquors which are as short as possible, with changing baths, are preferably used.

With the degreasing agents used in process step C) of the novel process, efficiencies of from at least 50 to 55% can be achieved in leather degreasing. The efficiency in % is defined as the dissolved amount of fat, i.e. the difference in the fat content before the degreasing (x₀) and after the degreasing (x₁), as a ratio of the fat content before the degreasing (x₀), i.e. as (x₀−x₁)·100/x₀.

After the degreasing, the degreased material is generally washed with water. In the preferred emulsifier degreasing, the wastewater pollution is reduced to the substances natural fat and surfactant. If desired, these substances can be separated from the aqueous phase by heating the aqueous mixture. At elevated temperatures, the nonionic surfactants used according to the invention have poorer solubility. As a result of the consequent loss of emulsifier activity, separation of the emulsion occurs. Methods for separating the water from the natural fat and the surfactant are known to a person skilled in the art.

Process step D) of the novel process comprises pretanning, tanning or retanning of pretreated pelts with tanning agents obtainable by reacting aldehydes of the formula D.1 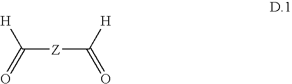
in the presence of an acidic catalyst and optionally in the presence of at least one further carbonyl compound of the formula D.2 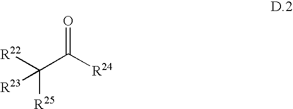
with the proviso that, if Z is a single chemical bond or a radical without α-hydrogen atoms, at least one further aldehyde of the formula D.1 in which Z contains α-hydrogen atoms or at least one further carbonyl compound of the formula D.2 is present.

In formula D.1, the variables are defined as follows:
Z is a single chemical bond,

C₁-C₁₂-alkylene, for example —CH₂—, —CH₂—CH₂—, —(CH₂)₃—, —(CH₂)₄—, —(CH₂)₅—, —(CH₂)₆—, —(CH₂)₇—, —(CH₂)₈—, —(CH₂)₉—, —(CH₂)₁₀—, —(CH₂)₁₁—, —(CH₂)₁₂—, cis- or trans-CH═CH—, Z- or E-CH₂—CH═CH—; preferably —CH₂—, —CH₂—CH₂—, —(CH₂)₃—, —(CH₂)₄—;
substituted C₁-C₁₂-alkylene, for example —CH(CH₃)—, —CH(C₆H₅)—, —CH(CH₃)—CH₂—, syn-CH(CH₃)—CH(CH₃)—, anti-CH(CH₃)—CH(CH₃)—, syn-CH(CH₃)—CH(C₆H₅)—, anti-CH(CH₃)—CH(C₆H₆)—, —(CH(CH₃))_{3—;}
unsubstituted or substituted C₅-C₁₂-cycloalkylene, for example trans- or cis-1,2-cyclopentylene, trans- or cis-1,3-cyclopentanylene, trans- or cis-1,3-cyclopent-4-enylene, trans- or cis-1,4-cyclohexanylene, trans- or cis-1,4-cyclohex-2-enylene, trans- or cis-1,3-cyclohexylene, trans- or cis-1,2-cyclohexylene, suitable substituents in each case being one or more C₁-C₄-alkyl groups, such as methyl, ethyl, n-propyl, isopropyl, n-butyl, sec-butyl, isobutyl or tert-butyl, or one or more halogen atoms, such as fluorine, chlorine, bromine or iodine; or
unsubstituted or substituted C₆-C₁₄-arylene, for example para-phenylene, meta-phenylene, ortho-phenylene, 1,2-naphthylene, 1,3-naphthylene, 1,4-naphthylene, 1,5-naphthylene, 1,6-naphthylene, 1,7-naphthylene, 1,8-naphthylene, 2,3-naphthylene, 2,7-naphthylene, 2,6-naphthylene, 1,4-anthrylene, 9,10-anthrylene or p,p′-biphenylene, suitable substituents in each case being one or more C₁-C₄-alkyl groups, such as methyl, ethyl, n-propyl, isopropyl, n-butyl, sec-butyl, isobutyl or tert-butyl, or one or more halogen atoms, such as fluorine, chlorine, bromine or iodine.

In formula D.2, the variables are defined as follows:
R²² to R²⁵, independently of one another, are hydrogen,
   C₁-C₁₂-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl, n-decyl or n-dodecyl; preferably C₁-C₆-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl or sec-hexyl, particularly preferably C₁-C₄-alkyl, such as methyl, ethyl, n-propyl, isopropyl, n-butyl, isobutyl, sec-butyl or tert-butyl, very particularly preferably methyl;
   unsubstituted or substituted C₃-C₁₂-cycloalkyl, such as cyclopropyl, cyclobutyl, cyclopentyl, cyclohexyl, cycloheptyl, cyclooctyl, cyclononyl, cyclodecyl, cycloundecyl or cyclododecyl; preferably cyclopentyl, cyclohexyl, cycloheptyl, 2-methylcyclopentyl, 3-methylcyclopentyl, cis-2,4-dimethylcyclopentyl, trans-2,4-dimethylcyclopentyl 2,2,4,4-tetramethylcyclopentyl, 2-methylcyclohexyl, 3-methylcyclohexyl, 4-methylcyclohexyl, cis-2,5-dimethylcyclohexyl, trans-2,5-dimethylcyclohexyl, 2,2,5,5-tetramethylcyclohexyl, 2-methoxycyclopentyl, 2-methoxycyclohexyl, 3-nethoxycyclopentyl, 3-methoxycyclohexyl, 2-chlorocyclopentyl, 3-chlorocyclopentyl, 2,4-dichlorocyclopentyl, 2,2,4,4-tetrachlorocyclopentyl, 2-chlorocyclohexyl, 3-chlorocyclohexyl, 4-chlorocyclohexyl, 2,5-dichlorocyclohexyl, 2,2,5,5-tetrachlorocyclohexyl, 2-thiomethylcyclopentyl, 2-thiomethylcyclohexyl, 3-thiomethylcyclopentyl or 3-thiomethylcyclohexyl;
   C₇-C₁₃-aralkyl, preferably C₇- to C₁₂-phenylalkyl, such as benzyl, 1-phenethyl, 2-phenethyl, 1-phenylpropyl, 2-phenylpropyl, 3-phenylpropyl, neophyl(l-methyl-l-phenylethyl), 1-phenylbutyl, 2-phenylbutyl, 3-phenylbutyl or 4-phenylbutyl, particularly preferably benzyl;
   C₆-C₁₄-aryl, such as phenyl, 1-naphthyl, 2-naphthyl, 1-anthryl, 2-anthryl, 9-anthryl, 1-phenanthryl, 2-phenanthryl, 3-phenanthryl, 4-phenanthryl or 9-phenanthryl, preferably phenyl, 1-naphthyl or 2-naphthyl, particularly preferably phenyl, unsubstituted or substituted by one or more
      C₁-C₁₂-alkyl groups, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl, n-decyl or n-dodecyl; preferably C₁-C₆-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, particularly preferably C₁-C₄-alkyl, such as methyl, ethyl, n-propyl, isopropyl, n-butyl, isobutyl, sec-butyl or tert-butyl;
      halogens, such as fluorine, chlorine, bromine or iodine, chlorine and bromine being preferred;
      C₁-C₁₂-alkoxy groups, preferably C₁-C₆-alkoxy groups, such as methoxy, ethoxy, n-propoxy, isopropoxy, n-butoxy, isobutoxy, sec-butoxy, tert-butoxy, n-pentyloxy, isopentyloxy, n-hexyloxy or isohexyloxy, particularly preferably methoxy, ethoxy, n-propoxy or n-butoxy.

In a preferred embodiment, R²² and R²³ or R²² and R²⁴ are covalently bonded to one another with formation of a 4- to 13-membered ring. For example, R²² and R²³ together may be: —(CH₂)₄—, —(CH₂)₅—, —(CH₂)₆, —(CH₂)₇—, —CH(CH₃)—CH₂—CH₂—CH(CH₃)— or —CH(CH₃)—CH₂—CH₂—CH₂—CH(CH₃)—.
R²² and R²³ are preferably each hydrogen.
Z is very particularly preferably —(CH₂)₃—.

The reaction for the preparation of the tanning agents used in process step D) of the novel process is preferably effected by heating D.1 to a temperature of from 30 to 130° C., in particular from 20 to 100° C., very particularly preferably from 50 to 80° C. The reaction can be carried out at any desired pressures from 0.1 to 100 bar, atmospheric pressure being preferred. The reaction can be effected in the presence of a solvent, for example in the presence of hydrocarbons, preferably toluene, petroleum ether or n-heptane. Halogenated hydrocarbons, for example chloroform, are in principle also suitable. The reaction in aqueous solution or aqueous dispersion is preferred.

Dehydrating agents may be added for accelerating the reaction, but the addition of dehydrating agents is not necessary. If the reaction is carried out in water as a solvent, the addition of dehydrating agents is of course not reasonable.

Catalysts used are acidic catalysts, for example phosphoric acid, formic acid, acetic acid, acidic silica gels or dilute or concentrated sulfuric acids. If nonaqueous solvents are employed, the use of P₂O₅ or a molecular sieve is also conceivable. Usually, from 0.1 to 20, preferably from 1 to 10, mol %, based on the amount of compound(s) D.1, of catalyst are used.

A reasonable reaction time for the reaction is from 10 minutes to 24 hours, preferably from one to three hours.

After the heating, working-up is usually effected by first neutralizing the acid, for example with aqueous alkali metal hydroxide solution or with aqueous alkali metal carbonate solution or with solid basic alkali metal compounds, for example alkali metal hydroxide, alkali metal carbonate or alkali metal bicarbonate. The volatile components of the reaction mixture can then be distilled off. As a rule, heating to 40 to 80° C. under reduced pressure, for example from 10 to 100 mbar, is expedient for this purpose.

In a preferred embodiment, aldehydes of the formula D.1 are reacted with from 1 to 1 000, preferably from 10 to 500, particularly preferably from 20 to 200, mol % of at least one further carbonyl compound, where carbonyl compounds are to be understood as meaning aldehydes and ketones.

The aldehydes and ketones used as further reactants preferably carry α-H atoms. Particularly preferred aldehydes and ketones are those of the formula D.2′ 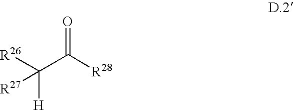
where R²⁶ to R²⁸, independently of one another, are hydrogen,
C₁-C₁₂-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl, n-decyl or n-dodecyl; preferably C₁-C₆-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, particularly preferably C₁-C₄-alkyl, such as methyl, ethyl, n-propyl, isopropyl, n-butyl, isobutyl, sec-butyl or tert-butyl, very particularly preferably methyl;
unsubstituted or substituted C₃-C₁₂-cycloalkyl, such as cyclopropyl, cyclobutyl, cyclopentyl, cyclohexyl, cycloheptyl, cyclooctyl, cyclononyl, cyclodecyl, cycloundecyl or cyclododecyl; preferably cyclopentyl, cyclohexyl, cycloheptyl, 2-methylcyclopentyl, 3-methylcyclopentyl, cis-2,4-dimethylcyclopentyl, trans-2,4-dimethylcyclopentyl 2,2,4,4-tetramethylcyclopentyl, 2-methylcyclohexyl, 3-methylcyclohexyl, 4-methylcyclohexyl, cis-2,5-dimethylcyclohexyl, trans-2,5-dimethylcyclohexyl, 2,2,5,5-tetramethylcyclohexyl, 2-methoxycyclopentyl, 2-methoxycyclohexyl, 3-methoxycyclopentyl, 3-methoxycyclohexyl, 2-chlorocyclopentyl, 3-chlorocyclopentyl, 2,4-dichlorocyclopentyl, 2,2,4,4-tetrachlorocyclopentyl, 2-chlorocyclohexyl, 3-chlorocyclohexyl, 4-chlorocyclohexyl, 2,5-dichlorocyclohexyl, 2,2,5,5-tetrachlorocyclohexyl, 2-thiomethylcyclopentyl, 2-thiomethylcyclohexyl, 3-thiomethylcyclopentyl or 3-thiomethylcyclohexyl;
C₇-C₁₃-aralkyl, preferably C₇- to C₁₂-phenylalkyl, such as benzyl, 1-phenethyl, 2-phenethyl, 1-phenylpropyl, 2-phenylpropyl, 3-phenylpropyl, neophyl(1-methyl-1-phenylethyl), 1-phenylbutyl, 2-phenylbutyl, 3-phenylbutyl or 4-phenylbutyl, particularly preferably benzyl;
C₆-C₁₄-aryl, such as phenyl, 1-naphthyl, 2-naphthyl, 1-anthryl, 2-anthryl, 9-anthryl, 1-phenanthryl, 2-phenanthryl, 3-phenanthryl, 4-phenanthryl or 9-phenanthryl, preferably phenyl, 1-naphthyl or 2-naphthyl, particularly preferably phenyl, unsubstituted or substituted by one or more
   C₁-C₁₂-alkyl groups, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl, n-decyl or n-dodecyl; preferably C₁-C₆-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, particularly preferably C₁-C₄-alkyl, such as methyl, ethyl, n-propyl, isopropyl, n-butyl, isobutyl, sec-butyl or tert-butyl;
   halogens, such as fluorine, chlorine, bromine or iodine, preferably chlorine or bromine;
   C₁-C₁₂-alkoxy groups, preferably C₁-C₆-alkoxy groups, such as methoxy, ethoxy, n-propoxy, isopropoxy, n-butoxy, isobutoxy, sec-butoxy, tert-butoxy, n-pentyloxy, isopentyloxy, n-hexyloxy or isohexyloxy, particularly preferably methoxy, ethoxy, n-propoxy or n-butoxy.

In a particular embodiment, R²⁶ and R²⁷ or R²⁶ and R²⁸ are covalently bonded to one another with formation of a 4- to 13-membered ring. For example, R²⁶ and R²⁷ together may be: —(CH₂)₄—, —(CH₂)₅—, —(CH₂)₆, —(CH₂)₇—, —CH(CH₃)—CH₂—CH₂—CH(CH₃)— or —CH(CH₃)—CH₂—CH₂—CH₂—CH(CH₃)—.

R²⁶ and R²⁷ are each particularly preferably hydrogen, and R²⁸ is methyl.

The reactions under the conditions described above usually take place with formation of mixtures which are difficult to separate and whose products result from dimerizations, oligomerizations (from 3 to 8 units) and polymerization (9 or more units) of the aldehyde of formula D.1, and furthermore form aldol addition reactions, possibly followed, for example, by elimination of water (dehydration), oxidations or intramolecular crosslinking. During the storage of the novel tanning agents, byproducts resulting from the storage may furthermore occur, for example due to elimination of water (dehydration), oxidation or dimerization, oligomerization or polymerization or due to crosslinking.

It is possible to isolate individual products of the reactions described above and to use them as tanning agents. However, a preferred aspect of the present invention is the use of the reaction products only incompletely purified or not further purified at all as tanning agents in process step D) of the novel process.

The tanning agents used according to the invention can be employed for the pretannning, tanning and retanning of animal hides.

According to the invention, pretreated hides of animals, for example cattle, pigs, goats or deer, are used as starting materials in process step D) of the novel process.

Process step D) of the novel process is generally carried out by adding one or more novel tanning agents in one portion or in a plurality of portions immediately before or during the tanning step. The novel tanning process is preferably carried out at pH of from 2.5 to 4, it frequently being observed that the pH increases by about 0.3 to three units while the novel tanning process is being carried out. The pH can also be increased by adding agents for increasing the basicity.

Process step D) of the novel process is carried out in general at from 10 to 45° C., preferably from 20 to 30° C. A duration of from 10 minutes to 12 hours, preferably from one to three hours, has proven useful. The novel tanning process can be carried out in any desired vessels customary in tanning, for example by drumming.

In one variant of process step D) of the novel process, the novel tanning agents are used together with one or more conventional tanning agents, for example with chrome tanning agents, mineral tanning agents, syntans, polymer tanning agents or vegetable tanning agents, as described, for example, in Ullmann's Encyclopedia of Industrial Chemistry, Volume A15, pages 259 to 282 and in particular page 268 et seq., 5th edition (1990), Verlag Chemie Weinheim. The weight ratio of novel tanning agent to conventional tanning agent or the sum of the conventional tanning agents is expediently from 0.01:1 to 100:1. In an advantageous variant of the novel process, only a few ppm of the conventional tanning agents are added to the novel tanning agents. However, it is particularly advantageous completely to dispense with the admixing of conventional tanning agents.

In one variant of process step D) of the novel process, one or more tanning agents described above are added in one portion or in a plurality of portions before or during the pretanning, in a particularly preferred variant during pickling itself.

In a further variant of process step D) of the novel process, one or more tanning agents described above are added in one portion or in a plurality of portions before or during one or more retanning steps. This variant of process step D) of the novel process can be carried out under otherwise conventional conditions. Expediently, one or more, i.e. from 2 to 6, treatment steps are chosen and washing with water can be effected between treatment steps. The temperature during the individual treatment steps is in each case from 5 to 60° C., preferably from 20 to 45° C. Further agents usually used during the retanning are expediently employed, for example fatliquor, polymer tanning agents and acrylate- and/or methacrylate-based fatliquoring agents, retanning reagents based on resin and vegetable tanning agents, fillers, leather dyes or emulsifiers.

In a special embodiment of process step D) of the novel process, the tanning agents described above are used in the form of pulverulent active ingredients. Such pulverulent active ingredients contain
from 10 to 100, preferably from 40 to 90, % by weight of one or more tanning agents described above
and from 0 to 90, preferably from 10 to 60, % by weight of one or more additives.

The additives are as a rule solid particulate substances. They are preferably chosen from starch, silica, for example in the form of silica gel, in particular spheroidal silica gels, sheet silicates, alumina and mixed oxides of silicon and aluminum.

Further additives are one or more conventional tanning agents or retanning agents, in particular resin tanning agents, for example the resin tanning agent sold under the name Relugan® D, Tamol® M and Basyntan® DLX by BASF Aktiengesellschaft. Ligninsulfonates are also suitable additives.

Typical of the pulverulent active ingredients is furthermore that they consist of fine particles having a mean particle diameter of from 100 nm to 0.1 mm. The particle diameters follow a particle diameter distribution which may be narrow or broad. Bimodal particle distributions are also conceivable. The particles themselves may have an irregular or spherical shape, spherical particle shapes being preferred. The novel pulverulent active ingredients can be metered under particularly hygienic conditions in the novel tanning process or retanning process.

The pulverulent active ingredients are prepared, for example, as follows: tanning agents described above which are present in solution, in suspension or in emulsion or in isolated form are used as starting materials. Reaction solutions as obtained in the preparation process described above are particularly preferably used as starting materials.

It has proven useful first to concentrate the reaction solutions to a residual solvent content of 50% by weight or less.

The resulting liquid, solid or oily concentrated reaction solutions are then sprayed in a spray dryer, preferably in a spray tower. Spray dryers are known to a person skilled in the art and are described, for example, in Vauck/Müller, Grundoperationen chemischer Verfahrenstechnik, VCH Weinheim, 1988, 7th edition, pages 638-740 and pages 765-766, and in the literature cited therein.

In a preferred embodiment, the novel process for the production of leather comprises at least the process steps A) and B).

In a further preferred embodiment, the novel process for the production of leather comprises at least the process steps A), B) and C).

A further preferred embodiment of the novel process for the production of leather comprises the process steps A) to D).

A particularly advantageous development of the novel process and its abovementioned preferred embodiments is obtained if, in process step A), at least step (a), i.e. the addition of one or more polyelectrolytes and from 0 to 1.5% by weight, based on the salted weight, of lime, is included immediately before or during liming.

As mentioned further above in the statements of process step A), the substantial saving of lime can be effected in comparison with the conventional procedure on addition of polyelectrolytes.

In the novel process and its preferred embodiments, no lime (0% by weight of lime) is therefore used in a particularly preferred variant in step (a) of process step A) (in this context, deliming in the conventional sense is then no longer necessary).

In combination with the use of compounds of the formula B.1, process wastewaters which have a substantially reduced content of inorganic salts compared with conventional wastewaters are therefore obtained. There are also indications that at least a part of the polyelectrolytes and the compounds B.1 is incorporated into the leather, which contributes further toward reducing the water pollution. Moreover, the structure of the leather is also advantageously influenced by this incorporation.

After the hairs have been separated off (in the case of hair-preserving liming), the proteins are precipitated, as a rule with addition of relatively strong acids, for example sulfuric acid or formic acid. In the case of hair-destroying liming, the removal of the hairs is omitted and the protein content of the wastewaters in this case is of course higher. The acidified process wastewater substantially freed from organic substances is therefore available for other process steps, but also for the presoaking and main soaking of fresh rawhides which, for stabilization, have generally being treated with salt prior to delivery. Depending on the desired use, it may be necessary also to adjust the pH.

A particularly advantageous process sequence claimed within the scope of the present invention, also with respect to the abovementioned preferred embodiments of the novel process, is accordingly distinguished by the fact that the process wastewater obtained after combination of process step A) (a) and process step B), i.e. after liming, and substantially freed from the organic components, in particular from proteins and any hairs, is at least partly used in at least one further process step of the process steps A) (b) to A) (d), C) and D) for the production of leather and/or for the presoaking and main soaking of the fresh rawhides.

The present invention therefore furthermore relates to those process wastewaters substantially freed from organic components, in particular from proteins or any hairs, which are obtainable after combination of process step A) (a) and process step B), i.e. after liming, according to the novel process for the production of leather.

As a result of the procedure described above, not only are process wastewaters which have to be disposed of in an expensive manner in the conventional beamhouse eliminated, but the acidified novel process wastewaters can be further used as dilute acids in further process steps.

The novel process wastewater is preferably used at least partly in step (b) of process step A) and/or in process step D) and/or for the presoaking and main soaking of the rawhides, particularly preferably in process step A) (b) and D) and for the presoaking and main soaking of the rawhides.

The present invention furthermore relates to leathers which have been produced by the novel process and its preferred embodiments.

The working examples below illustrate the invention.

### WORKING EXAMPLES

The values in % by weight are based in each case on the salted weight of the hide, unless stated otherwise.

General Working Methods:

1. Leather Production with Hair-Destroying Liming

1.1. Conventional Procedure V1

1.1.1. Soaking

100% by weight, based on the salted weight, of a South German cattle hide were first presoaked at 28° C. with 200% by weight of water and 0.2% by weight of Eusapon® W (detergent formulation based on oxo alcohol alkoxylates; BASF Aktiengesellschaft) for 120 minutes in a drum with gentle movement. The liquor was discharged (C1-1 Liquor for standard presoaking, 200% by weight) and soaking was then effected with 100% by weight of water, 0.2% by weight of Eusapon® W and 0.5% by weight of sodium carbonate with gentle movement for 15 hours. The liquor was then discharged (C1-2 Liquor for standard main soaking, 100% by weight).

1.1.2. Liming

For comparative example C1, 100% by weight, based on the salted weight, of a hide were treated in a rotatable 10 l drum with internal baffles in succession with 80% by weight of water and 1.0% by weight of Mollescal® LS (unhairing agent based on mercaptoethanol; BASF Aktiengesellschaft). After 30 minutes, 0.8% by weight of NaSH (70% strength) and 1% by weight of lime were added and left for a further 30 minutes. 0.75% by weight of sodium sulfide (60%) and 0.75% by weight of sodium sulfide together with 1.0% by weight of lime followed at an interval of 30 minutes. The drum was operated for a further 30 minutes at 15 revolutions/minute. A further 70% by weight of water, 1.0% by weight of lime and 0.04% by weight of Mollescal® AGN (polymeric liming assistant; BASF Aktiengesellschaft) were then metered. After 15 hours at from 23 to 27° C. and drum revolutions of in each case 5 minutes per hour at 3 revolutions/minute, the experiments were terminated by discharging the liquor (sample C1-3 Liquor for standard liming, 150% by weight) and washing the pelts once for 15 minutes with 150% by weight of water (sample C1-4 Wash liquor for standard liming, 150% by weight).

Before the further processing, the hides were fleshed and split (2.8 mm).

The times stated in the tables below are to be understood as meaning time intervals relative to the abovementioned product addition(s). If a plurality of products are added at a time, a time is stated only for the product mentioned last in the relevant block of the table and added at this time. If data on the dilution of a product are given, the stated percentages by weight are based on the undiluted product. The dilution was effected in each case with the water before the addition of the product. “Diluted 1:3” means, for example, that 1 part by weight of the (undiluted) product was diluted with 3 parts by weight of water.

1.1.3. Deliming

Below, the data in % by weight are based on the pelt weight, grain split 2.8 mm (corresponding to 75% salted weight), unless stated otherwise. The deliming was carried out at from 25 to 32° C.:

| Experi- | % by | | | Time |
|---|---|---|---|---|
| ment | wt. | Product | pH | [min] |
| C1 | 150 | Water, 2× | | 20 |
| | | Discharge liquor (C1-5/C1-6 Deliming | | |
| | | wash liquor, 300% by weight) | | |
| | 100 | Water | 8.6 | 20 |
| | 0.2 | Decaltal ®ES-N (pH-regulating deliming | | |
| | | agent based on organic esters; BASF | | |
| | | Aktiengesellschaft) | | |
| | 0.2 | Eusapon ®S (diluted 1:3; detergent | | |
| | | formulation based on oxo alcohol | | |
| | | alkxoylates; BASF Aktiengesellschaft) | | |
| | 0.2 | Sodium bisulfite | | |
| | | Discharge liquor (C1-7 Deliming | | |
| | | liquor, 100% by weight) | | |
| | 50 | Water | 8.0 | 45 |
| | 1.0 | Decaltal ®ES-N | | |
| | 1.0 | Basozym ®CM (enzymatic bating agent; | | 45 |
| | | BASF Aktiengesellschaft) | | |
| | | Discharge liquor (C1-8 Bating liquor, | | |
| | | 50% by weight) | | |
| | 150 | Water | | 10 |
| | | Discharge liquor (C1-9 Bating wash | | |
| | | liquor, 150% by weight) | | |

The penetration of the neutralization over the hide cross section was checked with phenolphthalein as indicator. The time required for this purpose was noted.

1.1.4. Pickling and Tanning

Below, the data in % by weight are based on the pelt weight of the hide, grain split 2.8 mm (corresponding to 75% salted weight), unless stated otherwise.

| Experi- | % by | | | Time |
|---|---|---|---|---|
| ment | wt. | Product | pH | [min] |
| C1 | 40 | Water | | 10 |
| | 6 | Sodium chloride (8° Be) | | |
| | 1.0 | Lipoderm ®fatliquor A1 (fatliquoring | | 20 |
| | | agent based on natural oils; BASF | | |
| | | Aktiengesellschaft; diluted 1:3) | | |
| | 0.4 | Formic acid (100% strength) (diluted | | 30 |
| | | 1:5) | | |
| | 0.8 | Sulfuric acid (98% strength) | 3.0 | 90 |
| | 2.5 | Relugan ®GTP (modified glutaraldehyde; | 3.0 | 90 |
| | | BASF Aktiengesellschaft; diluted 1:3) | | |
| | 3.0 | Basyntan ®SW liquid (sulfone-based | 3.9 | 900 |
| | | tanning agent; BASF | | |
| | | Aktiengesellschaft; diluted 1:2) | | |
| | 2.0 | Tamol ®NA (pH-regulating tanning | | |
| | | assistant; BASF Aktiengesellschaft) | | |
| | 0.2 | Sodium formate | | |
| | 0.2 | Sodium formate | 4.0 | 90 |
| | 0.2 | Sodium bicarbonate | | |
| | 0.2 | Cortymol ®FUN (fungicide; BASF | | 30 |
| | | Aktiengesellschaft; diluted 1:3) | | |
| | | Discharge liquor (C1-10 Tanning | | |
| | | liquor, 40% by weight) | | |

1.2. Novel Procedures N1 to N5
1.2.1. Soaking

100% by weight, based on the salted weight, of a South German cattle hide were first presoaked at 28° C. with 200% by weight of water and 0.2% by weight of a branched C₁₀-alcohol alkoxylate having 2 propylene oxide and 6 ethylene oxide units (surfactant 12; surfactant according to experiment 12 in table 2 of the prior German Patent Application 101 34 441.4) for 120 minutes in a drum with gentle movement. The liquor was discharged (NX-1 Presoaking liquor, 200% by weight; X=1, 2, 3, 4 or 5) and soaking was then effected with 100% by weight of water, 0.2% by weight of surfactant 12 and 0.5% by weight of sodium carbonate with gentle movement for 15 hours. The liquor was then discharged (NX-2 Main soaking liquor, 100% by weight; X=1, 2, 3, 4 or 5).

1.2.2. Liming

For the novel procedures N1 to N5, 100% by weight, based on the salted weight, of a hide were treated in a rotatable 10 l drum with internal baffles in succession with 50% by weight of water and as follows:

| Experi- | % by | | | Time |
|---|---|---|---|---|
| ment | wt. | Product | pH | [min] |
| N1 | 2.5 | PE 11 (polyethylenimine; | 10.5 | |
| | | Polyelectrolyte according to example | | |
| | | 11 in table 1 of the prior German | | |
| | | Patent Application 102 11 670.9) | | |
| | 1.5 | DTT (100%; racemic dithiothreitol; | 9.7 | 60 |
| | | Biosynth Aktiengesellschaft) | | |
| | 1.5 | Sodium hydroxide (50% strength | 10.7 | 30 |
| | | aqueous solution) | | |
| | 1.5 | Sodium hydroxide (50% strength | 12.4 | 60 |
| | | aqueous solution) | | |
| | 50 | Water | 12.4 | 900 |
| | | Discharge liquor (N1-3 Liming liquor, | | |
| | | 100% by weight) | | |
| | 150 | Water | | 10 |
| | | Discharge liquor (N1-4 Liming wash | | |
| | | liquor, 150% by weight) | | |

| Experi- | % by | | | Time |
|---|---|---|---|---|
| ment | wt. | Product | pH | [min] |
| N2 | 1.0 | Waterglass (50% strength aqueous | 9.7 | 60 |
| | | solution) | | |
| | 1.5 | DTT (100%) | 9.7 | 60 |
| | 1.5 | Sodium hydroxide (50% strength | 10.7 | 30 |
| | | aqueous solution) | | |
| | 1.5 | Sodium hydroxide (50% strength | 12.4 | 60 |
| | | aqueous solution) | | |
| | 50 | Water | 12.4 | 900 |
| | | Discharge liquor (N2-3 Liming liquor, | | |
| | | 100% by weight) | | |
| | 150 | Water | | 10 |
| | | Discharge liquor (N2-4 Liming wash | | |
| | | liquor, 150% by weight) | | |

| Experi- | % by | | | Time |
|---|---|---|---|---|
| ment | wt. | Product | pH | [min] |
| N3 | 1.0 | PE 8 (acrylic acid (AA)/maleic | | 60 |
| | | anhydride (MAA) copolymer, molar | | |
| | | AA:MAA ratio = 8:2; polyelectrolyte | | |
| | | according to example 8 in table 1 of | | |
| | | the prior German Patent Application | | |
| | | 102 11 670.9) | | |
| | 0.75 | DTT (100%) | | 60 |
| | 0.5 | Urea | | |
| | 1.5 | Sodium hydroxide (50% strength | 10.7 | 30 |
| | | aqueous solution) | | |
| | 1.5 | Sodium hydroxide (50% strength | 12.4 | 60 |
| | | aqueous solution) | | |
| | 50 | Water | 12.4 | 900 |
| | | Discharge liquor (N3-3 Liming liquor, | | |
| | | 100% by weight) | | |
| | 150 | Water | | 10 |
| | | Discharge liquor (N3-4 Liming wash | | |
| | | liquor, 150% by weight) | | |

| Experi- | % by | | | Time |
|---|---|---|---|---|
| ment | wt. | Product | pH | [min] |
| N4 | 0.5 | Mollescal ®MF (unhairing agent based | | 60 |
| | | on thioglycolic acid; BASF | | |
| | | Aktiengesellschaft) | | |
| | 0.5 | PE 14 (cationic starch; | | |
| | | polyelectrolyte according to example | | |
| | | 14 in table 1 of the prior German | | |
| | | Patent Application 102 11 670.9) | | |
| | 1.0 | DTT (100%) | | |
| | 2.0 | Sodium hydroxide (50% strength | 12.1 | 30 |
| | | aqueous solution) | | |
| | 0.4 | Sodium hydroxide (50% strength | | 60 |
| | | aqueous solution) | | |
| | 50 | Water | 12.4 | 900 |
| | | Discharge liquor (N3-4 Liming liquor, | | |
| | | 100% by weight) | | |
| | 150 | Water | | 10 |
| | | Discharge liquor | | |
| | | (N4-4 Liming wash liquor, 150% by | | |
| | | weight) | | |

| Experi- | % by | | | Time |
|---|---|---|---|---|
| ment | wt. | Product | pH | [min] |
| N5 | 1.0 | Basozym ®L10 (enzymatic bating | | 60 |
| | | assistant; BASF Aktiengesellschaft) | | |
| | 1.5 | DTT (100%) | | |
| | 2.0 | Sodium hydroxide (50% strength | | 30 |
| | | aqueous solution) | | |
| | 0.4 | Sodium hydroxide (50% strength | | 60 |
| | | aqueous solution) | | |
| | 50 | Water | 12.4 | 900 |
| | | Discharge liquor (N5-3 Liming liquor, | | |
| | | 100% by weight) | | |
| | 150 | Water | | 10 |
| | | Discharge liquor (N5-4 Liming wash | | |
| | | liquor, 150% by weight) | | |

Before the further processing, the hides were fleshed and split (2.8 mm).

1.2.3. Deliming

Below, the data in % by weight are based on the pelt weight, grain split 2.8 mm (corresponding to 75% salted weight), unless stated otherwise. The deliming was carried out at from 25 to 32° C.:

| Experi- | % by | | | Time |
|---|---|---|---|---|
| ment | wt. | Product | pH | [min] |
| N1 | 50 | Water | | 20 |
| | 0.2 | Decaltal ®ES-N | 8.6 | 20 |
| | 0.2 | Surfactant 12 (diluted 1:3) | | |
| | | Discharge liquor (N1-5 Deliming | | |
| | | liquor, 50% by weight) | | |
| | 50 | Water | 8.0 | 45 |
| | 1.0 | Decaltal ®ES-N | | |
| | 1.0 | Basozym ®CM | | 45 |
| | | Discharge liquor (N1-6 Bating liquor, | | |
| | | 50% by weight) | | |
| | 150 | Water | | 10 |
| | | Discharge liquor (N1-7 Bating wash | | |
| | | liquor, 150% by weight) | | |

| Experi- | % by | | | Time |
|---|---|---|---|---|
| ment | wt. | Product | pH | [min] |
| N2 | 50 | Water | | 20 |
| | 0.2 | Decaltal ®ES-N | 8.6 | 20 |
| | 0.2 | Surfactant 11 (surfactant according | | |
| | | to experiment 11 in table 2 of the | | |
| | | prior German Patent Application 101 | | |
| | | 34 441.4; diluted 1:3) | | |
| | | Discharge liquor (N2-5 Deliming | | |
| | | liquor, 50% by weight) | | |
| | 50 | Water | 8.0 | 45 |
| | 1.0 | Decaltal ®ES-N | | |
| | 1.0 | Basozym ®CM | | 45 |
| | | Discharge liquor (N2-6 Bating liquor, | | |
| | | 50% by weight) | | |
| | 150 | Water | | 10 |
| | | Discharge liquor (N2-7 Bating wash | | |
| | | liquor, 150% by weight) | | |

| Experi- | % by | | | Time |
|---|---|---|---|---|
| ment | wt. | Product | pH | [min] |
| N3 | 50 | Water | | 20 |
| | 0.2 | Decaltal ®ES-N | 8.6 | 20 |
| | 0.2 | Surfactant 20 (surfactant according | | |
| | | to experiment 20 in table 2 of the | | |
| | | prior German Patent Application 101 | | |
| | | 34 441.4; diluted 1:3) | | |
| | | Discharge liquor (N3-5 Deliming | | |
| | | liquor, 50% by weight) | | |
| | 50 | Water | 8.0 | 45 |
| | 1.0 | Decaltal ®ES-N | | |
| | 1.0 | Basozym ®CM | | 45 |
| | | Discharge liquor (N3-6 Bating liquor, | | |
| | | 50% by weight) | | |
| | 150 | Water | | 10 |
| | | Discharge liquor (N3-7 Bating wash | | |
| | | liquor, 150% by weight) | | |

| Experi- | % by | | | Time |
|---|---|---|---|---|
| ment | wt. | Product | pH | [min] |
| N4 | 50 | Water | | 20 |
| | 0.2 | Decaltal ®ES-N | 8.6 | 20 |
| | 0.2 | Surfactant 12 (diluted 1:3) | | |
| | | Discharge liquor (N4-5 Deliming | | |
| | | liquor, 50% by weight) | | |
| | 50 | Water | 8.0 | 45 |
| | 1.0 | Decaltal ®ES-N | | |
| | 1.0 | Basozym ®CM | | 45 |
| | | Discharge liquor (N4-6 Bating liquor, | | |
| | | 50% by weight) | | |
| | 150 | Water | | 10 |
| | | Discharge liquor (N4-7 Bating wash | | |
| | | liquor, 150% by weight) | | |

| Experi- | % by | | | Time |
|---|---|---|---|---|
| ment | wt. | Product | pH | [min] |
| N5 | 50 | Water | | 20 |
| | 0.2 | Decaltal ®ES-N | 8.6 | 20 |
| | 0.2 | Surfactant 12 (diluted 1:3) | | |
| | | Discharge liquor (N5-5 Deliming | | |
| | | liquor, 50% by weight). | | |
| | 50 | Water | 8.0 | 45 |
| | 1.0 | Decaltal ®ES-N | | |
| | 1.0 | Basozym ®CM | | 45 |
| | | Discharge liquor (N5-6 Bating liquor, | | |
| | | 50% by weight) | | |
| | 150 | Water | | 10 |
| | | Discharge liquor (N5-7 Bating wash | | |
| | | liquor, 150% by weight) | | |

The penetration of the neutralization over the hide cross section was checked with phenolphthalein as an indicator. The time required for this purpose was noted.

1.2.4. Pickling and Tanning

Below, the data in % by weight are based on the pelt weight, grain split 2.8 mm (corresponding to 75% salted weight), unless stated otherwise.

| Experi- | % by | | | Time |
|---|---|---|---|---|
| ment | wt. | Product | pH | [min] |
| N1 | 40 | Water | | 10 |
| | 0.5 | PE 11 | | |
| | 1.0 | Lipoderm ®fatliquor A1 (diluted 1:3) | | 20 |
| | 0.4 | Formic acid (100% strength) (diluted | | 30 |
| | | 1:5) | | |
| | 0.8 | Sulfuric acid (98% strength) | 2.9 | 90 |
| | 1.8 | TA 1 (tanning agent according to | 3.4 | 90 |
| | | example 1.1 of the prior German | | |
| | | Patent Application 102 31 293.1) | | |
| | 3.0 | Basyntan ®SW liquid (diluted 1:2) | 4.2 | 900 |
| | 2.0 | Tamol ®NA | | |
| | 1.0 | Sodium formate | 4.0 | 90 |
| | 0.2 | Sodium bicarbonate | | |
| | 0.2 | Cortymol ® FUN (diluted 1:3) | | 30 |
| | | Discharge liquor (N1-8 Tanning | | |
| | | liquor, 40% by weight) | | |

| Experi- | % by | | | Time |
|---|---|---|---|---|
| ment | wt. | Product | pH | [min] |
| N2 | 40 | Water | | 10 |
| | 1.0 | Waterglass (50% strength aqueous | | |
| | | solution) | | |
| | 1.0 | Lipoderm ®fatliquoring A1 (diluted | | 20 |
| | | 1:3) | | |
| | 0.4 | Formic acid (100% strength) (diluted | | 30 |
| | | 1:5) | | |
| | 0.8 | Sulfuric acid (98% strength) | 2.9 | 90 |
| | 1.8 | TA 4 (tanning agent according to | 3.4 | 90 |
| | | example 1.4 of the prior German | | |
| | | Patent Application 102 31 293.1) | | |
| | 3.0 | Basyntan ®SW liquid (diluted 1:2) | 4.2 | 900 |
| | 2.0 | Tamol ®NA | | |
| | 1.0 | Sodium formate | 4.0 | 90 |
| | 0.2 | Sodium bicarbonate | | |
| | 0.2 | Cortymol ®FUN (diluted 1:3) | | 30 |
| | | Discharge liquor (N2-8 Tanning | | |
| | | liquor, 40% by weight) | | |

| Experi- | % by | | | Time |
|---|---|---|---|---|
| ment | wt. | Product | pH | [min] |
| N3 | 40 | Water | | 10 |
| | 2.5 | PE 8 | | |
| | 1.0 | Lipoderm ® fatliquor A1 (diluted 1:3) | | 20 |
| | 0.4 | Formic acid (100% strength) (diluted | | 30 |
| | | 1:5) | | |
| | 0.8 | Sulfuric acid (98% strength) | 2.9 | 90 |
| | 1.8 | TA 3 (tanning agent according to | 3.4 | 90 |
| | | example 1.3 of the prior German | | |
| | | Patent Application 102 31 293.1) | | |
| | 3.0 | Basyntan ®SW liquid (diluted 1:2) | 4.2 | 900 |
| | 2.0 | Tamol ®NA | | |
| | 1.0 | Sodium formate | 4.0 | 90 |
| | 0.2 | Sodium bicarbonate | | |
| | 0.2 | Cortymol ®FUN (diluted 1:3) | | 30 |
| | | Discharge liquor (N1-8 Tanning | | |
| | | liquor, 40% by weight) | | |

| Experi- | % by | | | Time |
|---|---|---|---|---|
| ment | wt. | Product | pH | [min] |
| N4 | 40 | Water | | 10 |
| | 2.0 | PE 4 (polyacrylate sodium salt; | | |
| | | polyelectrolyte according to example | | |
| | | 4 in table 1 of the prior German | | |
| | | Patent Application 102 11 670.9) | | |
| | 1.0 | Lipoderm ® fatliquor A1 (diluted 1:3) | | 20 |
| | 0.4 | Formic acid (100% strength) (diluted | | 30 |
| | | 1:5) | | |
| | 0.8 | Sulfuric acid (98% strength) | 2.9 | 90 |
| | 1.8 | TA 2 (tanning agent according to | 3.4 | 90 |
| | | example 1.2 of the prior German | | |
| | | Patent Application 102 31 293.1) | | |
| | 3.0 | Basyntan ®SW liquid (diluted 1:2) | 4.2 | 900 |
| | 2.0 | Tamol ®NA | | |
| | 1.0 | Sodium formate | 4.0 | 90 |
| | 0.2 | Sodium bicarbonate | | |
| | 0.2 | Cortymol ®FUN (diluted 1:3) | | 30 |
| | | Discharge liquor (N1-8 Tanning | | |
| | | liquor, 40% by weight) | | |

| Experi- | % by | | | Time |
|---|---|---|---|---|
| ment | wt. | Product | pH | [min] |
| N5 | 40 | Water | | 10 |
| | 2.0 | PE 7 (polymethacrylic acid; | | |
| | | polyelectrolyte according to example | | |
| | | 7 in table 1 of the prior German | | |
| | | Patent Application 102 11 670.9) | | |
| | 1.0 | Lipoderm ® fatliquor A1 (diluted 1:3) | | 20 |
| | 0.4 | Formic acid (100% strength) (diluted | | 30 |
| | | 1:5) | | |
| | 0.8 | Sulfuric acid (98% strength) | 2.9 | 90 |
| | 1.8 | TA 1 | 3.4 | 90 |
| | 3.0 | Basyntan ®SW liquid (diluted 1:2) | 4.2 | 900 |
| | 2.0 | Tamol ®NA | | |
| | 1.0 | Sodium formate | 4.0 | 90 |
| | 0.2 | Sodium bicarbonate | | |
| | 0.2 | Cortymol ®FUN (diluted 1:3) | | 30 |
| | | Discharge liquor (N1-8 Tanning | | |
| | | liquor, 40% by weight) | | |

1.3. Novel Procedures N6 and N7 with Working-Up and Recycling of the Liquors
1.3.1. Soaking

100% by weight, based on the salted weight, of a South German cattle hide were first presoaked at 28° C. with 200% by weight of aqueous, purified liquor (NX-C; X=1, 2, 3, 4 or 5) and 0.1% by weight of surfactant 12 for 120 minutes in a drum with gentle movement. The liquor was discharged (NX-1 Presoaking liquor, 200% by weight) and then soaking was effected with a further 100% by weight of aqueous, purified liquor (NX-C), 0.1% by weight of surfactant 12 and 0.5% by weight of sodium carbonate with occasional movement for 15 hours. The liquor was then discharged (NX-2 Main soaking liquor, 100% by weight).

1.3.2. Liming

For the novel examples N6 to N7, 100% by weight, based on the salted weight, were treated in a rotatable 10 l drum with internal baffles in succession with 50% by weight of water and as follows:

| Experi- | % by | | | Time |
|---|---|---|---|---|
| ment | wt. | Product | pH | [min] |
| N6 | 2.5 | PE 11 | 10.5 | |
| (cf. | 1.5 | DTT (100%) | 9.7 | 60 |
| N1) | | | | |
| | 1.5 | Sodium hydroxide (50% strength | 10.7 | 30 |
| | | aqueous solution) | | |
| | 1.5 | Sodium hydroxide (50% strength | 12.4 | 60 |
| | | aqueous solution) | | |
| | 50 | Water | 12.4 | 900 |
| | | Discharge liquor (N6-3 Liming liquor, | | |
| | | 100% by weight) | | |
| | 150 | Water | | 10 |
| | | Discharge liquor (N6-4 Liming wash | | |
| | | liquor, 150% by weight) | | |

| Experi- | % by | | | Time |
|---|---|---|---|---|
| ment | wt. | Product | pH | [min] |
| N7 | 1.0 | Waterglass (50% strength aqueous | 9.7 | 60 |
| (cf. | | solution) | | |
| N2) | | | | |
| | 1.5 | DTT (100%) | 9.7 | 60 |
| | 1.5 | Sodium hydroxide (50% strength | 10.7 | 30 |
| | | aqueous solution) | | |
| | 1.5 | Sodium hydroxide (50% strength | 12.4 | 60 |
| | | aqueous solution) | | |
| | 50 | Water | 12.4 | 900 |
| | | Discharge liquor (N7-3 Liming liquor, | | |
| | | 100% by weight) | | |
| | 150 | Water | | 10 |
| | | Discharge liquor (N7-4 Liming wash | | |
| | | liquor, 150% by weight) | | |

Before the further processing, the hides were fleshed and split (2.8 mm).

The liquors NX-3 and NX-4 (X=6 and 7, respectively) were combined (250%) and brought to pH 4.5 with concentrated sulfuric acid (technical-grade, 98%). The precipitated protein was separated off using a chamber filter press. The data of the combined and purified liquors NX-3 and NX-4 are shown below under point 1.8 Summary of the results with hair-destroying liming (liquor NX-A, 250%; X=6 and 7, respectively).

1.3.3. Deliming

Below, the data in % by weight are based on the pelt weight, grain split 2.8 mm (corresponding to 75% salted weight), unless stated otherwise. The deliming was carried out at from 25 to 32° C.:

| Experi- | % by | | | Time |
|---|---|---|---|---|
| ment | wt | Product | pH | [min] |
| N6 | 50 | Aqueous, purified liquor (NX-A) | | 20 |
| (Cf. | | | | |
| N1) | | | | |
| | 0.2 | Decaltal ®ES-N | 8.6 | 20 |
| | 0.1 | Surfactant 12 (diluted 1:3) | | |
| | | Discharge liquor (N6-5 Deliming | | |
| | | liquor, 50% by weight) | | |
| | 50 | Water | 8.0 | 45 |
| | 1.0 | Decaltal ®ES-N | | |
| | 1.0 | Basozym ®CM | | 45 |
| | | Discharge liquor (N6-6 Bating liquor, | | |
| | | 50% by weight) | | |
| | 150 | Water | | 10 |
| | | Discharge liquor (N6-7 Bating wash | | |
| | | liquor, 150% by weight) | | |

| Experi- | % by | | | Time |
|---|---|---|---|---|
| ment | wt. | Product | pH | [min] |
| N7 | 50 | Aqueous, purified liquor (NX-A) | | 20 |
| (cf. | | | | |
| N2) | | | | |
| | 0.2 | Decaltal ®ES-N | 8.6 | 20 |
| | 0.1 | Surfactant 11 (diluted 1:3) | | |
| | | Discharge liquor (N7-5 Deliming | | |
| | | liquor, 50% by weight) | | |
| | 50 | Water | 8.0 | 45 |
| | 1.0 | Decaltal ®ES-N | | |
| | 1.0 | Basozym ®CM | | 45 |
| | | Discharge liquor (N7-6 Bating liquor, | | |
| | | 50% by weight) | | |
| | 150 | Water | | 10 |
| | | Discharge liquor (N7-7 Bating wash | | |
| | | liquor, 150% by weight) | | |

The penetration of the neutralization over the hide cross section was checked with phenolphthalein as an indicator. The time required for this purpose was noted.

The combined liquors NX-5, NX-6 and NX-7 give liquor NX-B (250%, pH 8; X=1, 2, 3, 4 or 5)

1.3.4. Pickling and Tanning

Below, the data in % by weight are based on the pelt weight, grain split 2.8 mm (corresponding to 75% salted weight), unless stated otherwise.

| Experi- | % by | | | Time |
|---|---|---|---|---|
| ment | wt. | Product | pH | [min] |
| N6 | 40 | Aqueous, purified liquor (NX-A) | | 10 |
| (cf. | 0.5 | PE 11 | | |
| N1) | | | | |
| | 1.0 | Lipoderm ® fatliquor A1 (diluted 1:3) | | 20 |
| | 0.4 | Formic acid (100% strength) (diluted | | 30 |
| | | 1:5) | | |
| | 0.8 | Sulfuric acid (98% strength) | 2.9 | 90 |
| | 1.8 | TA 1 | 3.4 | 90 |
| | 3.0 | Basyntan ®SW liquid (diluted 1:2) | 4.2 | 900 |
| | 2.0 | Tamol ®NA | | |
| | 1.0 | Sodium formate | 4.0 | 90 |
| | 0.2 | Sodium bicarbonate | | |
| | 0.2 | Cortymol ®FUN (diluted 1:3) | | 30 |
| | | Discharge liquor (N6-8 Tanning | | |
| | | liquor, 40% by weight) | | |

| Experi- | % by | | | Time |
|---|---|---|---|---|
| ment | wt. | Product | pH | [min] |
| E7 | 40 | Aqueous, purified liquor (NX-A) | | 10 |
| (cf. | 1.0 | Waterglass (50% strength aqueous | | |
| N2) | | solution) | | |
| | 1.0 | Lipoderm ® fatliquor A1 (diluted 1:3) | | 20 |
| | 0.4 | Formic acid (100% strength) (diluted | | 30 |
| | | 1:5) | | |
| | 0.8 | Sulfuric acid (98% strength) | 2.9 | 90 |
| | 1.8 | TA 4 | 3.4 | 90 |
| | 3.0 | Basyntan ®SW liquid (diluted 1:2) | 4.2 | 900 |
| | 2.0 | Tamol ®NA | | |
| | 1.0 | Sodium formate | 4.0 | 90 |
| | 0.2 | Sodium bicarbonate | | |
| | 0.2 | Cortymol ®FUN (diluted 1:3) | | 30 |
| | | Discharge liquor (N7-8 Tanning | | |
| | | liquor, 40% by weight) | | |

The remainder of the liquor NX-A (182%, based on salted weight, pH 4.5) and 118% of the liquor NX-B (based on salted weight, pH 8) were combined to give liquor NX-C (300%, based on salted weight, pH 6.5).

NX-8 (30%, based on salted weight, pH 4.5) and 71% of liquor NX-B (based on salted weight, pH 8) were disposed of.

1.4. Assessment of the Conventional Procedure C1 and of the Novel Procedures N1 to N7 According to Liming and the Corresponding Residual Liquors

The pelts obtained by the novel procedure are equivalent with regard to swelling to those obtained by the conventional procedure but are distinguished by a smoother and flatter grain, in particular those pelts obtained according to N4 to N7. The epidermis and the hairs with hair roots have been completely removed.

The residual liquors of the novel procedures can be acidified to pH 4.5 with organic or, preferably, inorganic acids, e.g. sulfuric acid, without evolution of hydrogen sulfide, and the precipitated proteins can be separated off without problems by filtration. The residual liquors treated in this manner are generally clear.

1.5. Further Processing of Comparative Example C1 and of Novel Examples N1 to N7 in the Retanning

In the case of comparative example C1 and of the novel example N1, the procedure was based on the data in the table shown below. The further processing of the novel examples N2 to N7 was carried out in an analogous manner.

Lipoderm® fatliquor LA (natural lecithin-based fatliquoring agent), Lipoderm® fatliquor FP (polymer fatliquoring agent), Lipoderm® Oil SK (sulfochlorinated liquid paraffin), Relugan® RV (polymer tanning agent), Basyntan® DLX-N (synthetic sulfone-based tanning agent) and Luganil® olive brown N (leather dye) are commercial products of BASF Aktiengesellschaft; Tara-Granofin® TA (natural tanning agent) is a commercial product of Clariant AG. The sources of the other commercial products have been mentioned elsewhere.

| % by | | Temp. | pH | | Time |
|---|---|---|---|---|---|
| wt. | Product | (° C.) | N1 | C1 | [min] |
| 150 | Water | 30 | | | 10 |
| 4.0 | Basyntan ®SW | | | | 30 |
| 1.5 | Tamol ®NA | | 5.4 | 5.0 | 20 |
| 0.3 | Sodium bicarbonate | | | | |
| 1.5 | Lipoderm ®Licker A1 | 60 | 5.4 | 5.0 | 30 |
| 1.0 | Lipoderm ®fat liquor LA | | | | |
| | Discharge liquor (C1-11 | | | | |
| | Neutralization liquor; NX-9 | | | | |
| | Neutralization liquor) | | | | |
| 150 | Water | 30 | | | 10 |
| | Discharge liquor, (C1-12 | | | | |
| | Neutralization wash liquor; | | | | |
| | NX-10 Neutralization wash | | | | |
| | liquor) | | | | |
| 70 | Water | 30 | | | 15 |
| 3.0 | Relugan ®RV | | | | |
| 10.0 | Basyntan ®SW | | 5.0 | 4.8 | 30 |
| 8.0 | Tara-Granofin ®TA | | | | |
| 4.0 | Basyntan ®DLX-N | | | | |
| 2.0 | Tamol ®NA | | 5.4 | 5.1 | 10 |
| 0.5 | Sodium bicarbonate | | | | |
| 2.0 | Luganil ®olive brown N | | complete | | 120 |
| | | | penetra- | | |
| | | | tion of | | |
| | | | dye | | |
| 0.5 | Formic acid (100%) (diluted | | | | 15 |
| | 1:10) | | | | |
| | Discharge liquor, (C1-13 | | | | |
| | Retanning liquor; NX-11 | | | | |
| | Retanning liquor) | | | | |
| 200 | Water | 60 | | | 15 |
| 3.0 | Lipoderm ® fatliquor FP (diluted | | | | |
| | 1:3) | | | | |
| 6.0 | Lipoderm ® fatliquor A1 | 60 | | | 60 |
| 2.0 | Lipoderm ® fatliquor LA | | | | |
| 2.0 | Lipoderm ® Oil SK | | | | |
| | (mixed and diluted 1:7) | | | | |
| 0.1 | Formic acid (100%) (diluted | | | | 15 |
| | 1:10) | | | | |
| 0.1 | Formic acid (100%) (diluted | | | | 20 |
| | 1:10) | | | | |
| 0.05 | Formic acid (100%) (diluted | | 3.1 | 3.1 | 15 |
| | 1:10) | | | | |
| | Discharge liquor (C1-14 | | | | |
| | Fatliquoring liquor; NX-12 | | | | |
| | Fatliquoring liquor) | | | | |
| 200 | Water | 50 | | | 20 |
| | Discharge liquor (C1-15 | | | | |
| | Fatliquoring wash liquor; NX-13 | | | | |
| | Fatliquoring wash liquor) | | | | |
| 200 | Water | 25 | | | 15 |
| 0.3 | Cortymol ®FUN | | | | |

The leathers thus obtained were sammed and shaved by conventional methods. The shaved thickness of the leathers was 2.0-2.2 mm (shaved weight corresponds to 25% of salted weight).

The leathers obtained were worked up in a conventional manner and their physical properties and performance characteristics were then tested.

1.6. Assessment of the Crust Leathers Obtained by Conventional Procedure C1 and Novel Procedures N1 to N7

Apart from the smoother and finer grains of procedures N4 to N7, the crust leathers produced according to the invention do not differ in their haptic and optical properties from the conventional crust leathers. Leathers having a very good dyeing and good tight-grained character in combination with very good body and excellent softness with elegant handle are obtained.

| | Quality of the | | Stitch tear |
|---|---|---|---|
| | hair removal, | Grain | resistance |
| | epidermis | tightness* | according to DIN |
| | removal and hide | Wet white | 53331 |
| Procedure | pigment removal* | leather | [N] |
| C1 | 2 | 2 | 140 |
| N1 | 2 | 2 | 176 |
| N2 | 1.5 | 2 | 173 |
| N3 | 1 | 2 | 178 |
| N4 | 1 | 1 | 185 |
| N5 | 1 | 1 | 190 |
| N6 | 2 | 1 | 188 |
| N7 | 1.5 | 2 | 178 |

*Evaluation by rating

1.7. Analysis of the Liquors

All liquor data are based on the salted weight (COD: chemical oxygen demand):

| Sam- | | | Sulfide | COD | |
|---|---|---|---|---|---|
| ple | Process | pH | [ppm]* | [mg O₂/l] | Liquor |
| C1-1 | Standard presoaking | | 1.3 | 8200 | 200 |
| | liquor | | | | |
| C1-2 | Standard main soaking | 9.5 | 2.0 | 11300 | 100 |
| | liquor | | | | |
| C1-3 | Standard liming liquor | 12.3 | 1000 | 48500 | 150 |
| | | | (430) | | |
| C1-4 | Standard liming wash | 12.3 | 310 | 8900 | 150 |
| | liquor | | | | |
| C1-5 | Deliming wash liquor | 12.0 | 57 | 4500 | 113 |
| C1-6 | Deliming wash liquor | 11.9 | 105 | 2500 | 113 |
| C1-7 | Deliming liquor | 8.6 | 73 | 1600 | 75 |
| C1-8 | Bating liquor | 8.0 | — | 16500 | 38 |
| C1-9 | Bating wash liquor | 8.0 | — | 2400 | 113 |
| C1-10 | Tanning liquor | 4.0 | — | 14700 | 30 |
| | Total up to tanning | | | 12600 | 1080 |
| C1-11 | Neutralization liquor | 5.0 | — | 18000 | 38 |
| C1-12 | Neutralization wash | 5.1 | — | 7150 | 38 |
| | liquor | | | | |
| C1-13 | Retanning liquor | 3.1 | — | 41500 | 18 |
| C1-14 | Fatliquoring liquor | 3.1 | — | 17000 | 50 |
| C1-15 | Fatliquoring wash liquor | 3.1 | — | 5500 | 50 |
| | Total up to crust | | | 12900 | 1273 |

| Sam- | | | Sulfide | COD | |
|---|---|---|---|---|---|
| ple | Process | pH | [ppm]* | [mg O₂/l] | Liquor |
| N1-1 | Presoaking liquor | 8.3 | 2.5 | 8200 | 200 |
| N1-2 | Main soaking liquor | 9.4 | 2.5 | 11300 | 100 |
| N1-3 | Liming liquor | 12.4 | 74 (6) | 72750 | 100 |
| N1-4 | Liming wash liquor | 12.4 | 36 | 15900 | 150 |
| N1-5 | Deliming liquor | 8.5 | 9 | 1600 | 38 |
| N1-6 | Bating liquor | 8.0 | — | 16500 | 38 |
| N1-7 | Bating wash liquor | 8.0 | — | 2400 | 113 |
| N1-8 | Tanning liquor | 4.0 | — | 14700 | 30 |
| | Total up to tanning | | | 18000 | 768 |
| N1-9 | Neutralization liquor | 5.4 | — | 15000 | 38 |
| N1-10 | Neutralization wash | 5.4 | — | 6300 | 38 |
| | liquor | | | | |
| N1-11 | Retanning liquor | 3.1 | — | 37500 | 18 |
| N1-12 | Fatliquoring liquor | 3.1 | — | 10550 | 50 |
| N1-13 | Fatliquoring wash liquor | 3.1 | — | 3950 | 50 |
| | Total up to crust | | | 16700 | 960 |
| N2-1 | Presoaking liquor | 8.3 | 2.0 | 8500 | 200 |
| N2-2 | Main soaking liquor | 9.4 | 2.0 | 10900 | 100 |
| N2-3 | Liming liquor | 12.4 | 70 (4) | 71500 | 100 |
| N2-4 | Liming wash liquor | 12.4 | 33 | 16300 | 150 |
| N2-5 | Deliming liquor | 8.5 | 7 | 1800 | 38 |
| N2-6 | Bating liquor | 8.0 | — | 15600 | 38 |
| N2-7 | Bating wash liquor | 7.9 | — | 2200 | 113 |
| N2-8 | Tanning liquor | 4.0 | — | 15200 | 30 |
| | Total up to tanning | | | 17900 | 768 |
| N2-9 | Neutralization liquor | 5.5 | — | 14800 | 38 |
| N2-10 | Neutralization wash | 5.5 | — | 5900 | 38 |
| | liquor | | | | |
| N2-11 | Retanning liquor | 3.0 | — | 36900 | 18 |
| N2-12 | Fatliquoring liquor | 3.0 | — | 9900 | 50 |
| N2-13 | Fat liquoring wash liquor | 3.0 | — | 4500 | 50 |
| | Total up to crust | | | 16500 | 960 |

| Sam- | | | Sulfide | COD | |
|---|---|---|---|---|---|
| ple | Process | pH | [ppm]* | [mg O₂/l] | Liquor |
| N3-1 | Presoaking liquor | 8.3 | 2.5 | 8000 | 200 |
| N3-2 | Main soaking liquor | 9.4 | 2.5 | 12000 | 100 |
| N3-3 | Liming liquor | 12.4 | 65 (5) | 73000 | 100 |
| N3-4 | Liming wash liquor | 12.4 | 37 | 15200 | 150 |
| N3-5 | Deliming liquor | 8.5 | 8 | 1700 | 38 |
| N3-6 | Bating liquor | 8.1 | — | 15900 | 38 |
| N3-7 | Bating wash liquor | 8.1 | — | 2300 | 113 |
| N3-8 | Tanning liquor | 4.1 | — | 14200 | 30 |
| | Total up to tanning | | | 17900 | 768 |
| N3-9 | Neutralization liquor | 5.4 | — | 15600 | 38 |
| N3-10 | Neutralization wash | 5.4 | — | 6500 | 38 |
| | liquor | | | | |
| N3-11 | Retanning liquor | 3.0 | — | 35500 | 18 |
| N3-12 | Fatliquoring liquor | 3.0 | — | 11100 | 50 |
| N3-13 | Fatliquoring wash liquor | 3.1 | — | 3700 | 50 |
| | Total up to crust | | | 16600 | 960 |

| Sam- | | | Sulfide | COD | |
|---|---|---|---|---|---|
| ple | Process | pH | [ppm]* | [mg O₂/l] | Liquor |
| N4-1 | Presoaking liquor | 8.3 | 2.5 | 8100 | 200 |
| N4-2 | Main soaking liquor | 9.4 | 2.5 | 11500 | 100 |
| N4-3 | Liming liquor | 12.4 | 72 (6) | 72500 | 100 |
| N4-4 | Liming wash liquor | 12.4 | 35 | 16100 | 150 |
| N4-5 | Deliming liquor | 8.5 | 9 | 1750 | 38 |
| N4-6 | Bating liquor | 7.9 | — | 16300 | 38 |
| N4-7 | Bating wash liquor | 8.0 | — | 2600 | 113 |
| N4-8 | Tanning liquor | 4.0 | — | 14100 | 30 |
| | Total up to tanning | | | 18000 | 768 |
| N4-9 | Neutralization liquor | 5.3 | — | 14800 | 38 |
| N4-10 | Neutralization wash | 5.3 | — | 6200 | 38 |
| | liquor | | | | |
| N4-11 | Retanning liquor | 3.1 | — | 38000 | 18 |
| N4-12 | Fatliquoring liquor | 3.1 | — | 10900 | 50 |
| N4-13 | Fatliquoring wash liquor | 3.1 | — | 4000 | 50 |
| | Total up to crust | | | 16700 | 960 |

| Sam- | | | Sulfide | COD | |
|---|---|---|---|---|---|
| ple | Process | pH | [ppm]* | [mg O₂/l] | Liquor |
| N5-1 | Presoaking liquor | 8.3 | 2.5 | 8700 | 200 |
| N5-2 | Main soaking liquor | 9.4 | 2.5 | 11000 | 100 |
| N5-3 | Liming liquor | 12.4 | 77 (6) | 73000 | 100 |
| N5-4 | Liming wash liquor | 12.4 | 36 | 17000 | 150 |
| N5-5 | Deliming liquor | 8.5 | 9 | 1500 | 38 |
| N5-6 | Bating liquor | 8.2 | — | 15200 | 38 |
| N5-7 | Bating wash liquor | 8.2 | — | 2500 | 113 |
| N5-8 | Tanning liquor | 4.0 | — | 14200 | 30 |
| | Total up to tanning | | | 18300 | 768 |
| N5-9 | Neutralization liquor | 5.5 | — | 15100 | 38 |
| N5-10 | Neutralization wash | 5.5 | — | 6150 | 38 |
| | liquor | | | | |
| N5-11 | Retanning liquor | 3.1 | — | 37500 | 18 |
| N5-12 | Fatliquoring liquor | 3.1 | — | 10700 | 50 |
| N5-13 | Fatliquoring wash liquor | 3.1 | — | 4100 | 50 |
| | Total up to crust | | | 16900 | 960 |

| Sam- | | | Sulfide | COD | |
|---|---|---|---|---|---|
| ple | Process | pH | [ppm]* | [mg O₂/l] | Liquor |
| N6-1 | Presoaking liquor | 8.3 | 2.5 | 19400 | 200 |
| N6-2 | Main soaking liquor | 9.4 | 2.5 | 22500 | 100 |
| N6-3 | Liming liquor | 12.4 | 74 (6) | 72750 | 100 |
| N6-4 | Liming wash liquor | 12.4 | 36 | 15900 | 150 |
| N6-5 | Deliming liquor | 8.5 | 9 | 14300 | 38 |
| N6-6 | Bating liquor | 8.0 | — | 16500 | 38 |
| N6-7 | Bating wash liquor | 7.9 | — | 2400 | 113 |
| N6-8 | Tanning liquor | 4.0 | — | 27400 | 30 |
| | Total up to tanning | | | 18300 | 401 |
| N6-9 | Neutralization liquor | 5.5 | — | 15000 | 38 |
| N6-10 | Neutralization wash | 5.4 | — | 6300 | 38 |
| | liquor | | | | |
| N6-11 | Retanning liquor | 3.0 | — | 37500 | 18 |
| N6-12 | Fatliquoring liquor | 3.1 | — | 10550 | 50 |
| N6-13 | Fatliquoring wash liquor | 3.1 | — | 3950 | 50 |
| | Total up to crust | | | 14200 | 593 |

| Sam- | | | Sulfide | COD | |
|---|---|---|---|---|---|
| ple | Process | pH | [ppm]* | [mg O₂/l] | Liquor |
| N7-1 | Presoaking liquor | 8.3 | 2.0 | 16000 | 200 |
| N7-2 | Main soaking liquor | 9.4 | 2.0 | 19100 | 100 |
| N7-3 | Liming liquor | 12.4 | 63 (5) | 72750 | 100 |
| N7-4 | Liming wash liquor | 12.4 | 30 | 15900 | 150 |
| N7-5 | Deliming liquor | 8.5 | 5 | 8100 | 50 |
| N7-6 | Bating liquor | 8.0 | — | 16500 | 50 |
| N7-7 | Bating wash liquor | 8.0 | — | 2400 | 150 |
| N7-8 | Tanning liquor | 4.0 | — | 21200 | 30 |
| | Total up to tanning | | | 14500 | 401 |
| N7-9 | Neutralization liquor | 5.4 | — | 15000 | 38 |
| N7-10 | Neutralization wash | 5.4 | — | 6300 | 38 |
| | liquor | | | | |
| N7-11 | Retanning liquor | 2.9 | — | 37500 | 18 |
| N7-12 | Fatliquoring liquor | 2.9 | — | 10550 | 50 |
| N7-13 | Fatliquoring wash liquor | 2.9 | — | 3950 | 50 |
| | Total up to crust | | | 10800 | 593 |

*The sulfide determination was effected in the form of hydrogen sulfide after acidification of the sample with concentrated hydrochloric acid, heating to 90° C. and stripping. Values stated in brackets relate to sulfide determinations by cold stripping of hydrogen sulfide with buffer solutions at pH 4.
Only sulfide present in free form as hydrogen sulfide is detected by the latter method of determination.

1.8. Summary of the Results with Hair-Destroying Liming

Comparison for soaking 1000 kg salted weight:

| | Water | Water | | | |
|---|---|---|---|---|---|
| | consumption | consumption | | | |
| | up to | up to | | CODₜₒₜₐₗ | |
| Experi- | tanning | tanning | COD | [kg | COD |
| ment | [m³] | [rel. %] | [mg O₂/l] | O₂/kg] | [rel. %] |
| C1 | 10.80 | 100 | 12600 | 136.2 | 100 |
| N1 | 7.68 | 71 | 18000 | 138.2 | 101 |
| N2 | 7.68 | 71 | 17900 | 137.4 | 101 |
| N3 | 7.68 | 71 | 17900 | 137.3 | 101 |
| N4 | 7.68 | 71 | 18000 | 138.3 | 102 |
| N5 | 7.68 | 71 | 18300 | 140.2 | 103 |
| N6 | 4.01 | 37 | 18300 | 73.2 | 54 |
| N7 | 4.01 | 37 | 14500 | 58.0 | 43 |

| | Water | Water | | | |
|---|---|---|---|---|---|
| | consumption | consumption | | CODₜₒₜₐₗ | |
| Experi- | up to crust | up to crust | COD | [kg | COD |
| ment | [m³] | [rel. %] | [mg O₂/l] | O₂/kg] | [rel. %] |
| C1 | 12.73 | 100 | 12900 | 164.1 | 100 |
| N1 | 9.60 | 75 | 16700 | 160.0 | 97 |
| N2 | 9.60 | 75 | 16500 | 158.8 | 97 |
| N3 | 9.60 | 75 | 16600 | 159.2 | 97 |
| N4 | 9.60 | 75 | 16700 | 160.3 | 98 |
| N5 | 9.60 | 75 | 16900 | 162.2 | 99 |
| N6 | 5.93 | 47 | 14200 | 84.2 | 51 |
| N7 | 5.93 | 47 | 10800 | 64.0 | 39 |

Protein precipitate from N6 and N7:
N6: Yield: 100 kg, dry substance: 30%, COD [mg O₂/kg]: 64 800, ash content: 1.0%;
N7: Yield: 125 kg, dry substance: 30%, COD [mg O₂/kg]: 80 300, ash content: 1.4%

Worked-up and reused liquors from N6 and N7:

| | | | | | COD | |
|---|---|---|---|---|---|---|
| | | | DS | Ash | [mg | Liquor |
| Liquor | Process | pH | [%] | [%] | O₂/l] | [%] |
| N6-A | N6-3 + N6-4 (before | 12.5 | 7.8 | 0.8 | 38600 | 250 |
| | precipitation) | | | | | |
| N6-A | N6-3 + N6-4 (after | 4.5 | 5.7 | 2.6 | 12700 | 250 |
| | precipitation) | | | | | |
| N6-B | N6-5 + N6-6 + E6-7 | 8 | 1.7 | 0.5 | 7600 | 189 |
| N6-C | N6-A (182%) + N6-B | 6.5 | 4.1 | 1.2 | 10700 | 300 |
| | (118%) | | | | | |
| N6-D | N6-1 + N6-2 + N6-B | 6.5 | — | — | 18300 | 401 |
| | (71%) + N6-8 | | | | | |

| | | | | | COD | |
|---|---|---|---|---|---|---|
| | | | DS | Ash | [mg | Liquor |
| Liquor | Process | pH | [%] | [%] | O₂/l] | [%] |
| N7-A | N7-3 + N7-4 (before | 12.5 | 7.8 | 0.8 | 38600 | 250 |
| | precipitation) | | | | | |
| N7-A | N7-3 + N7-4 (after | 4.5 | 5.7 | 2.6 | 6500 | 250 |
| | precipitation) | | | | | |
| N7-B | N7-5 + N7-6 + N7-7 | 8 | 1.7 | 0.5 | 6400 | 189 |
| N7-C | N7-A (182%) + N7-B | 6.5 | 4.1 | 1.2 | 6500 | 300 |
| | (118%) | | | | | |
| N7-D | N7-1 + N7-2 + N7-B | 6.5 | — | — | 14500 | 401 |
| | (71%) + N7-8 | | | | | |

2. Leather Production with Hair-Preserving Ash
2.1. Conventional Procedure V2
2.1.1. Soaking

100% by weight, based on the salted weight, of a South German cattle hide were first presoaked at 28° C. with 200% by weight of water and 0.2% by weight of Eusapon® W for 120 minutes in a drum with gentle movement. The liquor was discharged (C2-1 Standard presoaking liquor, 200% by weight) and soaking was then effected with 100% by weight of water, 0.2% by weight of Eusapon® W and 0.5% by weight of sodium carbonate with occasional movement for 15 hours. The liquor was then discharged (C2-2 Standard main soaking liquor, 100% by weight).

2.1.2. Liming

For comparative example C2, 100% by weight, based on the salted weight, were treated in a rotatable 10 l drum with internal baffles in succession with 60% by weight of water and, in each case after 60 minutes, 1.2% by weight of Mollescal MF, 0.8% by weight of lime and 1% by weight of sodium sulfide (60%). This was followed by the beginning of filtration with a duration of 120 minutes. Additions of 1.6% by weight of lime and 40% by weight of water followed at an interval of 60 minutes. After 15 hours at from 23 to 27° C. and drum revolutions of in each case 5 minutes per hour at 3 revolutions/minute, the experiments were terminated by discharging the liquor (sample C2-3 Standard liming liquor, 100% by weight) and the pelt was washed once for 15 minutes with 150% by weight of water (sample C2-4 Standard liming wash liquor, 150% by weight).

Before the further processing, the hides were fleshed and split (2.8 mm).

2.1.3. Deliming

Below, the data in % by weight are based on the pelt weight, grain split 2.8 mm (corresponding to 75% salted weight), unless stated otherwise. The deliming was carried out at from 25 to 32° C.:

| Experi- | % by | | | Time |
|---|---|---|---|---|
| ment | wt. | Product | pH | [min] |
| C2 | 150 | Water, 2× | | 20 |
| | | Discharge liquor | | |
| | | (C2-5/C2-6 Deliming wash liquor, 300% | | |
| | | by weight) | | |
| | 100 | Water | 8.6 | 20 |
| | 0.2 | Decaltal ®ES-N | | |
| | 0.2 | Eusapon ® S (diluted 1:3) | | |
| | 0.2 | Sodium bisulfite | | |
| | | Discharge liquor (C2-7 Deliming | | |
| | | liquor, 100% by weight) | | |
| | 50 | Water | 8.0 | 45 |
| | 1.0 | Decaltal ® ES-N | | |
| | 1.0 | Basozym ® CM | | 45 |
| | | Discharge liquor (C2-8 Bating liquor, | | |
| | | 50% by weight) | | |
| | 150 | Water | | 10 |
| | | Discharge liquor (C2-9 Bating wash | | |
| | | liquor, 150% by weight) | | |

The penetration of the neutralization over the hide cross section was checked with phenolphthalein as an indicator. The time required for this purpose was noted.

2.1.4. Pickling and Tanning

Below, the data in % by weight are based on the pelt weight, grain split 2.8 mm (corresponding to 75% salted weight), unless stated otherwise.

| Experi- | % by | | | Time |
|---|---|---|---|---|
| ment | wt. | Product | pH | [min] |
| C2 | 40 | Water | | 10 |
| | 6 | Sodium chloride (8° Be) | | |
| | 1.0 | Lipoderm fatliquor A1 (diluted 1:3) | | 20 |
| | 0.4 | Formic acid (100% strength) (diluted | | 30 |
| | | 1:5) | | |
| | 0.8 | Sulfuric acid (98% strength) | 3.0 | 90 |
| | 2.5 | Relugan ® GTP (diluted 1:3) | 3.0 | 90 |
| | 3.0 | Basyntan ® SW liquid (diluted 1:2) | 3.9 | 900 |
| | 2.0 | Tamol ® NA | | |
| | 0.2 | Sodium formate | | |
| | 0.2 | Sodium formate | 4.0 | 90 |
| | 0.2 | Sodium bicarbonate | | |
| | 0.2 | Cortymol ® FUN (diluted 1:3) | | 30 |
| | | Discharge liquor (C2-10 Tanning | | |
| | | liquor, 40% by weight) | | |

2.2. Novel Procedure N8 with Working-Up and Recycling of the Liquors
2.2.1. Soaking

100% by weight, based on the salted weight, of a South German cattle hide were first presoaked at 28° C. with 200% by weight of aqueous, purified liquor (NX-C) and 0.1% by weight of surfactant 12 for 120 minutes in a drum with gentle movement. The liquor was discharged (N8-1 Presoaking liquor, 200% by weight) and soaking was then effected with a further 100% by weight of aqueous, purified liquor (NX-C), 0.1% by weight of surfactant 12 and 0.5% by weight of sodium carbonate with occasional movement for 15 hours. The liquor was then discharged (N8-2 Main soaking liquor, 100% by weight).

2.2.2. Liming

For the novel procedure N8, 100% by weight, based on the salted weight, were treated in a rotatable 10 l drum with internal baffles in succession with 60% by weight of water and as follows:

| Experi- | % by | | | Time |
|---|---|---|---|---|
| ment | wt. | Product | pH | [min] |
| N8 | 2.5 | PE 11 | 10.5 | |
| | 1.0 | DTT (100%) | 9.7 | 60 |
| | 0.8 | Sodium hydroxide (50% strength | | 30 |
| | | aqueous solution) | | |
| option- | | Separation of the (lime-free) hairs | | 120 |
| al | | from the protein | | |
| | 1.2 | Sodium hydroxide (50% strength | | 30 |
| | | aqueous solution) | | |
| | 0.4 | Sodium hydroxide (50% strength | | 60 |
| | | aqueous solution) | | |
| | 40 | Water | 12.4 | 900 |
| | | Discharge liquor (N8-3 Liming liquor, | | |
| | | 100% by weight) | | |
| | 150 | Water | | 10 |
| | | Discharge liquor | | |
| | | (N8-4 Liming wash liquor, 150% by | | |
| | | weight) | | |

Before the further processing, the hides were fleshed and split (2.8 mm).

The liquors N8-3 and N8-4 were combined (250%) and brought to pH 4.5 with concentrated sulfuric acid (technical-grade, 98%). The precipitated protein was separated off using a chamber filter press. The data of the combined and purified liquors N8-3 and N8-4 are shown below under point 2.7 Summary of the results with hair-preserving liming (liquor N8-A, 250%).

2.2.3. Deliming

Below, the data in % by weight are based on the pelt weight, grain split 2.8 mm (corresponding to 75% salted weight), unless stated otherwise. The deliming was carried out at from 25 to 32° C.:

| Experi- | % by | | | Time |
|---|---|---|---|---|
| ment | wt. | Product | pH | [min] |
| N8 | 50 | Aqueous, purified liquor (N8-A) | | 20 |
| | 0.2 | Decaltal ® ES-N | 8.6 | 20 |
| | 0.1 | Surfactant 12 (diluted 1:3) | | |
| | | Discharge liquor (N8-5 Deliming | | |
| | | liquor, 50% by weight) | | |
| | 50 | Water | | |
| | 1.0 | Decaltal ® ES-N | 8.0 | 45 |
| | 1.0 | Basozym ® CM | | 45 |
| | | Discharge liquor (N8-6 Bating liquor, | | |
| | | 50% by weight) | | |
| | 150 | Water | | 10 |
| | | Discharge liquor (N8-7 Bating wash | | |
| | | liquor, 150% by weight) | | |

The penetration of the neutralization over the hide cross section was checked with phenolphthalein as an indicator. The time required for this purpose was noted.

The combined liquors N8-5, N8-6 and N8-7 give liquor N8-B (250%, pH 8)

2.2.4. Pickling and Tanning

Below, the data in % by weight are based on the pelt weight, grain split 2.8 mm (corresponding to 75% salted weight), unless stated otherwise.

| Experi- | % by | | | Time |
|---|---|---|---|---|
| ment | wt. | Product | pH | [min] |
| N8 | 40 | Aqueous, purified liquor (N8-A) | | 10 |
| | 0.5 | PE 11 | | |
| | 1.0 | Lipoderm fatliquor A1 (diluted 1:3) | | 20 |
| | 0.4 | Formic acid (100% strength) (diluted | | 30 |
| | | 1:5) | | |
| | 0.8 | Sulfuric acid (98% strength) | 2.9 | 90 |
| | 1.8 | TA 1 | 3.4 | 90 |
| | 3.0 | Basyntan ® SW liquid (diluted 1:2) | 4.2 | 900 |
| | 2.0 | Tamol ® NA | | |
| | 1.0 | Sodium formate | 4.0 | 90 |
| | 0.2 | Sodium bicarbonate | | |
| | 0.2 | Cortymol ® FUN (diluted 1:3) | | 30 |
| | | Discharge liquor (N8-8 Tanning | | |
| | | liquor, 40% by weight) | | |

The remainder of the liquor N8-A (182%, based on the salted weight, pH 4.5) and 118% of the liquor N8-B (based on the salted weight, pH 8) were combined to give the liquor N8-C (300%, based on the salted weight, pH 6.5). N8-8 (30%, based on the salted weight, pH 4.5) and 71% of the liquor N8-B (based on the salted weight, pH 8) were disposed of.

2.3. Assessment of the Conventional Procedure C2 and of the Novel Procedure N8 According to Liming and the Corresponding Residual Liquors

The pelts obtained by the novel procedure are equivalent with regard to swelling to those obtained by the conventional procedure but are distinguished by a smoother and flatter grain. The epidermis and the hairs with hair roots have been completely destroyed.

The residual liquors of the novel procedure can be acidified to pH 4.5 with organic or, preferably, inorganic acids, e.g. sulfuric acid, without evolution of hydrogen sulfide, and the precipitated proteins can be separated off without problems by filtration. The residual liquors prepared in this manner are as a rule clear.

2.4. Further Processing of Comparative Example C2 and of Novel Example N8 in Retanning

The procedure was as shown in the table below.

| % by | | Temp. | pH | | Time |
|---|---|---|---|---|---|
| wt. | Product | (° C.) | N8 | C2 | [min] |
| 150 | Water | 30 | | | 10 |
| 4.0 | Basyntan ®SW | | | | 30 |
| 1.5 | Tamol ®NA | | 5.4 | 5.0 | 20 |
| 0.3 | Sodium bicarbonate | | | | |
| 1.5 | Lipoderm ®fatliquor A1 | 60 | 5.4 | 5.0 | 30 |
| 1.0 | Lipoderm ®fatliquor LA | | | | |
| | Discharge liquor (C2-11 | | | | |
| | Neutralization liquor; N8-9 | | | | |
| | Neutralization liquor) | | | | |
| 150 | Water | 30 | | | 10 |
| | Discharge liquor (C2-12 | | | | |
| | Neutralization wash liquor; | | | | |
| | N8-10 Neutralization wash | | | | |
| | liquor) | | | | |
| 70 | Water | 30 | | | 15 |
| 3.0 | Relugan ®RV | | | | |
| 10.0 | Basyntan ®SW | | 5.0 | 4.8 | 30 |
| 8.0 | Tara-Granofin ®TA | | | | |
| 4.0 | Basyntan ®DLX-N | | | | |
| 2.0 | Tamol ®NA | | 5.4 | 5.1 | 10 |
| 0.5 | Sodium bicarbonate | | | | |
| 2.0 | Luganil ®olive brown N | | complete | | 120 |
| | | | penetra- | | |
| | | | tion of | | |
| | | | dye | | |
| 0.5 | Formic acid (100%) (diluted | | | | 15 |
| | 1:10) | | | | |
| | Discharge liquor (C2-13 | | | | |
| | Retanning liquor; N8-11 | | | | |
| | Retanning liquor) | | | | |
| 200 | Water | 60 | | | 15 |
| 3.0 | Lipoderm ® fatliquor FP (diluted | | | | |
| | 1:3) | | | | |
| 6.0 | Lipoderm ® fatliquor A1 | 60 | | | 60 |
| 2.0 | Lipoderm ® fatliquor LA | | | | |
| 2.0 | Lipoderm ® Oil SK | | | | |
| | (mixed and diluted 1:7) | | | | |
| 0.1 | Formic acid (100%) (diluted | | | | 15 |
| | 1:10) | | | | |
| 0.1 | Formic acid (100%) (diluted | | | | 20 |
| | 1:10) | | | | |
| 0.05 | Formic acid (100%) (diluted | | 3.1 | 3.1 | 15 |
| | 1:10) | | | | |
| | Discharge liquor (C2-14 | | | | |
| | Fatliquoring liquor; N8-12 | | | | |
| | Fatliquoring liquor) | | | | |
| 200 | Water | 50 | | | 20 |
| | Discharge liquor (C2-15 | | | | |
| | Fatliquoring wash liquor; N8-13 | | | | |
| | Fatliquoring wash liquor) | | | | |
| 200 | Water | 25 | | | 15 |
| 0.3 | Cortymol ®FUN | | | | |

The leathers thus obtained were sammed and shaved by conventional methods. The shaved thickness of the leathers was 2.0-2.2 mm (shaved weight corresponds to 25% salted weight).

The leathers obtained were worked up in a conventional manner and their physical properties and performance characteristics were then tested.

2.5. Assessment of the Crust Leathers Obtained by Conventional Procedure C2 and Novel Procedure N8

The crust leather produced according to the invention does not differ in its haptic and optical properties from the conventional crust leather. Leather having a very good dyeing and a good tight-grained character in combination with very good body and excellent softness with elegant handle is obtained.

| | Quality of the | | Stitch tear |
|---|---|---|---|
| | hair removal, | Grain | resistance |
| | epidermis | tightness* | according to DIN |
| | removal and hide | Wet white | 53331 |
| Procedure | pigment removal* | leather | [N] |
| C2 | 2 | 2 | 140 |
| N8 | 2 | 2 | 176 |

*Evaluation based on rating

2.6. Analysis of the Liquors

All liquor data are based on salted weight:

| Sam- | | | Sulfide | COD | |
|---|---|---|---|---|---|
| ple | Process | pH | [ppm]* | [mg O₂/l] | Liquor |
| C2-1 | Standard presoaking | | 1.3 | 8200 | 200 |
| | liquor | | | | |
| C2-2 | Standard main soaking | 9.5 | 2.0 | 11300 | 100 |
| | liquor | | | | |
| C2-3 | Standard liming liquor | 12.3 | 500 | 28200 | 100 |
| | | | (210) | | |
| C2-4 | Standard liming wash | 12.3 | 150 | 5500 | 150 |
| | liquor | | | | |
| C2-5 | Deliming wash liquor | 12.0 | 31 | 2500 | 113 |
| C2-6 | Deliming wash liquor | 11.9 | 53 | 1800 | 113 |
| C2-7 | Deliming liquor | 8.6 | 39 | 900 | 75 |
| C2-8 | Bating liquor | 8.0 | — | 16500 | 38 |
| C2-9 | Bating wash liquor | 8.0 | — | 2400 | 113 |
| C2-10 | Tanning liquor | 4.0 | — | 14700 | 30 |
| | Total up to tanning | | | 8100 | 1030 |
| C2-11 | Neutralization liquor | 5.0 | — | 18000 | 38 |
| C2-12 | Neutralization wash | 5.1 | — | 7150 | 38 |
| | liquor | | | | |
| C2-13 | Retanning liquor | 3.1 | — | 41500 | 18 |
| C2-14 | Fatliquoring liquor | 3.1 | — | 17000 | 50 |
| C2-15 | Fatliquoring wash liquor | 3.1 | — | 5500 | 50 |
| | Total up to crust | | | 9100 | 1223 |

| Sam- | | | Sulfide | COD | |
|---|---|---|---|---|---|
| ple | Process | pH | [ppm]* | [mg O₂/l] | Liquor |
| N8-1 | Presoaking liquor | 8.3 | 2.5 | 14400 | 200 |
| N8-2 | Main soaking liquor | 9.4 | 2.5 | 17500 | 100 |
| N8-3 | Liming liquor | 12.4 | 50 (4) | 25800 | 100 |
| N8-4 | Liming wash liquor | 12.4 | 12 | 5500 | 150 |
| N8-5 | Deliming liquor | 8.5 | 6 | 7000 | 38 |
| N8-6 | Bating liquor | 8.0 | — | 16500 | 38 |
| N8-7 | Bating wash liquor | 8.0 | — | 2400 | 113 |
| N8-8 | Tanning liquor | 4.0 | — | 20900 | 30 |
| | Total up to tanning | | | 14200 | 400 |
| N8-9 | Neutralization liquor | 5.4 | — | 15000 | 38 |
| N8-10 | Neutralization wash | 5.4 | — | 6300 | 38 |
| | liquor | | | | |
| N8-11 | Retanning liquor | 3.1 | — | 37500 | 18 |
| N8-12 | Fatliquoring liquor | 3.1 | — | 10550 | 50 |
| N8-13 | Fatliquoring wash liquor | 3.1 | — | 3950 | 50 |
| | Total up to crust | | | 10600 | 593 |

2.7. Summary of the Results with Hair-Preserving Liming

Comparison for soaking 1 000 kg salted weight:

| | Water | Water | | | |
|---|---|---|---|---|---|
| | consumption | consumption | | | |
| | up to | up to | | CODₜₒₜₐₗ | |
| Experi- | tanning | tanning | COD | [kg | COD |
| ment | [m³] | [rel. %] | [mg O₂/l] | O₂/kg] | [rel. %] |
| C2 | 10.30 | 100 | 8100 | 83.4 | 100 |
| N8 | 4.01 | 39 | 14200 | 56.8 | 68 |

| | Water | Water | | | |
|---|---|---|---|---|---|
| | consumption | consumption | | CODₜₒₜₐₗ | |
| Experi- | up to crust | up to crust | COD | [kg | COD |
| ment | [m³] | [rel. %] | [mg O₂/l] | O₂/kg] | [rel. %] |
| C2 | 12.23 | 100 | 9100 | 111.3 | 100 |
| N8 | 5.93 | 48 | 10600 | 62.9 | 57 |

Protein precipitate from N8:
N8: Yield: 100 kg, dry substance: 30%, COD [kg O₂/kg]: 18.9 Ash content: 1.0%

Worked-up and reused liquors from N8:

| | | | | | COD | |
|---|---|---|---|---|---|---|
| | | | DS | Ash | [mg | Liquor |
| Liquor | Process | pH | [%] | [%] | O₂/l] | [%] |
| N8-A | N8-3 + N8-4 (before | 12.5 | 7.8 | 0.8 | 38600 | 250 |
| | precipitation) | | | | | |
| N8-A | N8-3 + N8-4 (after | 4.5 | 5.7 | 2.6 | 6200 | 250 |
| | precipitation) | | | | | |
| N8-B | N8-5 + N8-6 + N8-7 | 8 | 1.7 | 0.5 | 6100 | 189 |
| N8-C | N8-A (182%) + N8-B | 6.5 | 4.1 | 1.2 | 6200 | 300 |
| | (118%) | | | | | |
| N8-D | N8-1 + N8-2 + N8-B | 6.5 | — | — | 14200 | 401 |
| | (71%) + N8-8 | | | | | |

3. Overall Comparison for Soaking for 1 000 kg Salted Weight

| | Water | Water | | | |
|---|---|---|---|---|---|
| | consumption | consumption | COD | | |
| Experi- | up to | up to tanning | [mg | CODₜₒₜₐₗ | COD |
| ment | tanning [m³] | [rel. %] | O₂/l] | [kg O₂] | [rel. %] |
| C1 | 10.80 | 100 | 12600 | 136.2 | 100 |
| C2 | 10.30 | 95 | 8100 | 83.4 | 61 |
| N1 | 7.68 | 71 | 18000 | 138.2 | 101 |
| N2 | 7.68 | 71 | 17900 | 137.4 | 101 |
| N3 | 7.68 | 71 | 17900 | 137.3 | 101 |
| N4 | 7.68 | 71 | 18000 | 138.3 | 102 |
| N5 | 7.68 | 71 | 18300 | 140.2 | 103 |
| N6 | 4.01 | 37 | 18300 | 73.2 | 54 |
| N7 | 4.01 | 37 | 14500 | 58.0 | 43 |
| N8 | 4.01 | 37 | 14200 | 56.8 | 42 |

| | Water | Water | | | |
|---|---|---|---|---|---|
| | consumption | consumption | COD | | |
| Experi- | up to | up to crust | [mg | CODₜₒₜₐₗ | COD |
| ment | crust [m³] | [rel. %] | O₂/l] | [kg O₂] | [rel. %] |
| C1 | 12.73 | 100 | 12900 | 164.1 | 100 |
| C2 | 12.23 | 96 | 9100 | 111.3 | 68 |
| N1 | 9.60 | 75 | 16700 | 160.0 | 97 |
| N2 | 9.60 | 75 | 16500 | 158.8 | 97 |
| N3 | 9.60 | 75 | 16600 | 159.2 | 97 |
| N4 | 9.60 | 75 | 16700 | 160.3 | 98 |
| N5 | 9.60 | 75 | 16900 | 162.2 | 99 |
| N6 | 5.93 | 47 | 14200 | 84.2 | 51 |
| N7 | 5.93 | 47 | 10800 | 64.0 | 39 |
| N8 | 5.93 | 47 | 10600 | 62.9 | 38 |

The overall comparison of the preceding tables shows in an impressive manner that the water consumption in the novel production of leather can be reduced to about 70 to 75% and, with liquor recycling, a preferred novel procedure, even to about 40 to 50% of the water consumption of the conventional procedure.

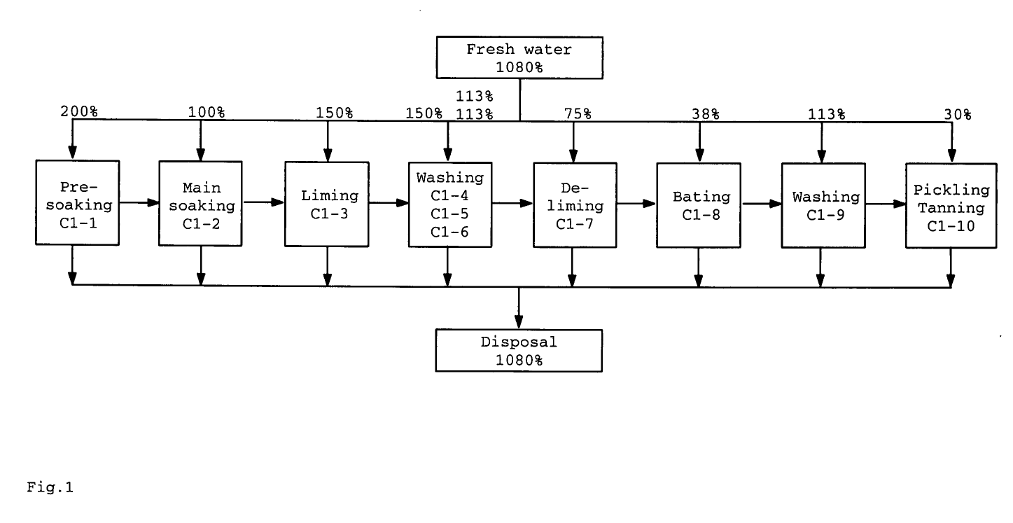

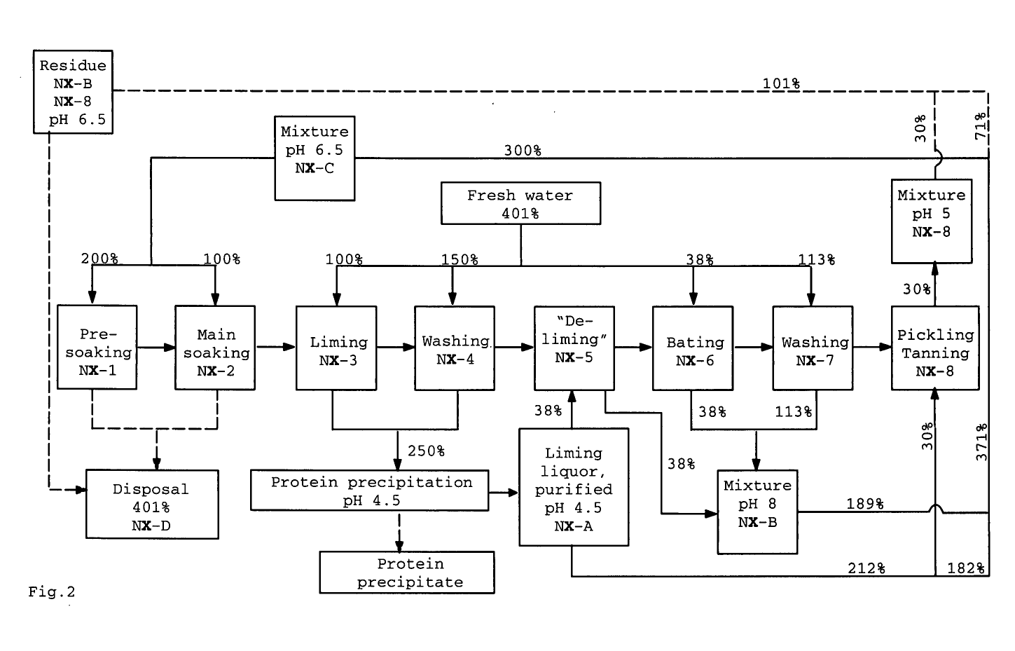

FIG. 1 and FIG. 2 once again give an overview of the water/wastewater streams (liquor streams) in the beamhouse for the conventional procedure C1 (also applies in context to procedure C2) and the preferred novel procedures NX (X=6, 7 or 8) with liquor recycling. As stated at the appropriate points, the percentages of water/wastewater streams (liquor streams) are based on the salted weight of the hides and are shown under point 1.7. Analysis of the liquors (for C1, N6 and N7) and point 2.6. Analysis of the liquors (for N8) in the respective tables.

It is furthermore advantageous that the protein (hydrolysis product) present in the liquor after the liming can for the most art be removed by the novel procedure by acidic precipitation and, owing to its low content of inorganic salts (cf. the abovementioned ash contents), can be used for a high-quality application, e.g. as a feed additive.

The decrease in the concentration of organic pollutants produced in the wastewaters of the beamhouse—depending on the procedure, the absolute COD value can be reduced to about 40 to 50% of the value for the conventional procedure—furthermore leads to a substantial cost reduction in their disposal (note: owing to the lower water consumptions in the novel procedure, the concentration data for the COD are for the most part higher than in (hair-destroying) procedure C1. If, however, the absolute COD values (COD total) or the relative amounts based on the absolute COD value of C1 are considered, said reductions in organic pollutants in the wastewater result in particular for experiments N6 to N8 (liquor recycling after prior protein precipitation).

1. A process for the production of leather, comprising at least two of the following process steps A) to D):
A) use of one or more polyelectrolytes in the production of semifinished products or intermediate products, comprising at least one of the steps (a) to (d)
(a) addition of one or more polyelectrolytes and from 0 to 1.5% by weight, based on the salted weight, of lime, immediately before or during liming,
(b) addition of one or more polyelectrolytes before or during deliming,
(c) addition of one or more polyelectrolytes before or during bating,
(d) addition of one or more polyelectrolytes and, altogether, from 0 to 3% by weight, based on the pelt weight, of alkali metal or alkaline earth metal salt, immediately before or during pickling;
B) treatment of the hides during liming in aqueous liquor with one or more compounds of the formula B.1 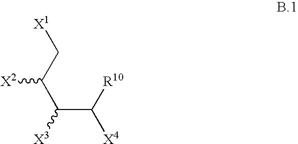
or the corresponding alkali metal, alkaline earth metal, ammonium or phosphonium salts thereof,
wherein:
R¹⁰ is hydrogen or C₁-C₁₂-alkyl which is unsubstituted or substituted by one or more mercapto or hydroxyl groups,
X₁ to X⁴, independently of one another, are hydrogen, C₁-C₄-alkyl, hydroxyl, mercapto or NHR¹¹ and
R¹¹ is hydrogen, C₁-C₁₂-alkyl, formyl or C₁-C₄-alkylcarbonyl,
wherein at least two mercapto groups are comprised in the compound or the compounds B.1;
C) use of degreasing agents of the formula C.1 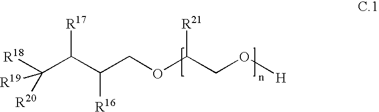
for degreasing pelts, hides or other intermediate products and semifinished products in leather production,
wherein:
R¹⁶ to R¹⁹, independently of one another, are hydrogen or branched or straight-chain C₁-C₁₀-alkyl,
R₂₀ is hydrogen or C₁-C₂₅-alkyl,
R₂₁ is hydrogen or C₁-C₄-alkyl and
n is an integer from 1 to 100,
R¹⁶ corresponding to C₁-C₁₀-alkyl when R¹⁸ to R²⁰ are each hydrogen and at least one of the radicals R¹⁸ to R²⁰ corresponding to C₁-C₂₅-alkyl when R¹⁶ is hydrogen;
D) tanning with the use of a tanning agent which can be prepared by reacting at least one aldehyde of the formula D.1, 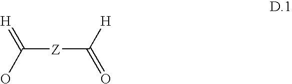
with at least one further identical or different aldehyde of the formula D.1,
wherein:
Z is a single chemical bond, unsubstituted or substituted C₁-C₁₂-alkylene, unsubstituted or substituted C₅-C₁₂-cycloalkylene or unsubstituted or substituted C₆-C₁₄-arylene,
the reaction being carried out in the presence of an acidic catalyst and optionally in the presence of at least one further carbonyl compound of the formula D.2 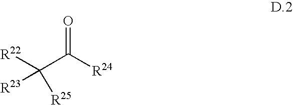
wherein:
R²² to R²⁵, independently of one another, are hydrogen, unsubstituted or substituted C₁-C₁₂-alkyl, unsubstituted or substituted C₃-C₁₂-cycloalkyl, unsubstituted or substituted C₇-C₁₃-aralkyl or unsubstituted or substituted C₆-C₁₄-aryl,
wherein at least one further aldehyde of the formula D.1 in which Z comprises a-hydrogen atoms, or at least one further carbonyl compound of the formula D.2, is present when Z corresponds to a single chemical bond or to a radical without a-hydrogen atoms.

2. A process as claimed in claim 1, comprising the process steps A) and B).

3. A process as claimed in claim 1, comprising the process steps A), B) and C).

4. A process as claimed in claim 1, comprising the process steps A) to D).

5. A process as claimed in claim 2, wherein the step (a) is comprised in process step A).

6. A process as claimed in claim 1, wherein no lime (0% by weight of lime) is used in step (a) of process step A).

7. A process as claimed in claim 1, wherein one or more hydroxylamine compounds of the formula A.15.a or A.15.b 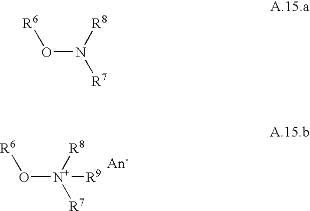
or one or more unprotonated or protonated hydrazine compounds of the formula A.16 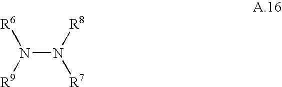
are additionally introduced in step (a) of process step A),
wherein
R⁶ to R⁹, independently of one another, are hydrogen, C₁-C₂₀-alkyl or C₆-C₁₄-aryl and
An⁻ is halide, sulfate, hydrogen sulfate, phosphate, hydrogen phosphate or dihydrogen phosphate or a mixture of said anions.

8. A process as claimed in claim 7, wherein hydroxylamine is added in step (a) of process step A).

9. A process as claimed in claim 5, wherein alkali metal hydroxide and/or alkali metal carbonate are additionally used in step (a) of process step A).

10. A process as claimed in claim 5, wherein the process water obtained after combination of process step A) (a) and process step B) and substantially freed from the organic components, is used at least partly in at least one further step of process steps A)(b) to A)(d), C) and D) for the production of leather and/or for the presoak and main soak of the rawhides.

11. A process as claimed in claim 10, wherein the process water obtained after combination of process step A) (a) and process step B) and substantially freed from the organic components, is used at least partly in step (b) of process step A) and/or in process step D) and/or for the presoak and main soak of the rawhides.

12. A process water substantially freed from organic components, obtained after combination of process step A) (a) and process step B) by a process for the production of leather as claimed in claim 5.

13. A leather which has been produced by a process as claimed in claim 1.
